(19) United States
(12) Patent Application Publication
(10) Pub. No.: US 2011/0132685 A1
(43) Pub. Date: Jun. 9, 2011

(54) SCAFFOLDING

(76) Inventor: Lewis Alberto Grijo Dos Santos, Send (GB)

(21) Appl. No.: 12/737,469

(22) PCT Filed: Jul. 10, 2009
(86) PCT No.: PCT/EP2009/058818

§ 371 Date: Jan. 18, 2011

(30) Foreign Application Priority Data
Jul. 18, 2008 (GB) 0813177.3

(51) Int. Cl. E04G 5/14; B23P 11/00

(52) U.S. Cl. 182/113; 29/897.31

(57) ABSTRACT

A scaffolding side frame (10) has at least one generally horizontally extending tube (11), a pair of vertically extending side tubes (12) depending from the horizontal tube, and four fastening members (17), one adjacent each corner of the frame, for securing the side frame to a respective adjacent structural element of an associated scaffold structure so that the upper part of the side frame provides a safety rail for an operator standing on a support platform of a given level of a scaffolding structure and the lower part of the side frame extends below the support platform of said given level of the scaffold structure. The two lower fastening members are hook-shaped and the hooks have a fastening latch (19). The latch (19) is displaceable to a retracted position in which the hook can be snapped over the adjacent structural element of the structure. The side frame (10) is mountable in its operating position by an operator holding the lower part of the frame whilst standing on a support platform of a level of the structure below said given level and engaging the fastening members (17) with their respective adjacent structural elements so that the side frame immediately becomes and remains a full load transmitting structural part of the associated scaffold structure. The configuration of the fastening latches (19) of the lower fastening members (17) preventing the operator disengaging the lower fastening members when stood on the support platform of said given level of the scaffold structure.

This invention relates to scaffolding and in particular to the provision of side frames for use in scaffolding towers and other scaffolding structures.

There is a requirement for a side frame which is easy to install in its operational position and which meets the mandatory guard rail requirements for the scaffolding.

Thus in accordance with a first aspect of the present invention there is provided a scaffolding side frame comprising at least one generally horizontally extending tube, a pair of vertically extending side tubes depending from the horizontal tube, and four fastening members, one adjacent each corner of the frame, for securing the side frame to a respective adjacent structural element of an associated scaffold structure so that the upper part of the side frame provides a safety rail for an operator standing on a support platform of a given level of a scaffolding structure and the lower part of the side frame extends below the support platform of said given level of the scaffold structure, the two lower fastening members being hook-shaped and the hooks having a fastening latch positioned adjacent the mouth of the hook which when in an active projecting position retains any adjacent structural element within the hook, the latch being displaceable to a retracted position in which the hook can be snapped over the adjacent structural element of the structure, the side frame being mountable in its operating position by an operator holding the lower part of the frame whilst standing on a support platform of a level of the structure below said given level and engaging the fastening members with their respective adjacent structural elements so that the side frame immediately becomes and remains a full load transmitting structural part of the associated scaffold structure, and the configuration of the fastening latches of the lower fastening members preventing the operator disengaging the lower fastening members when stood on the support platform of said given level of the scaffold structure.

If, for example, such a side frame is used in a tower scaffolding comprising end frames one above the other and decking elements extending between horizontal members of the end frames on different levels, the entire structural connection between two end frames at a given level of the tower can be provided by two side frames which also provide the mandatory guard rail requirements between the end frames at said given level.

This makes the scaffolding tower very easy and safe to erect by positioning the end frames for said given level in position from the level below and then raising the two side frames into position and connecting the side frames structurally with the end frames whilst standing on the level below, followed by adding the decking element of said given level which extend between the end frames. Thus said given level of the tower is fully completed from the level below before the operator steps onto the decking elements of said given level.

As will be appreciated, the side frame of the present invention can be used not only in tower scaffolding but in scaffolding structures in general with the side frame in position between adjacent vertical elements of the scaffolding structure and providing the sole structural connection and guard rail function between said adjacent vertical elements.

Conveniently the fastening members may engage a horizontal end frame member when the invention is used in a tower scaffolding or a horizontal transom member secured to an adjacent vertical element when the side frame is used in larger scaffolding structures.

The fastening latch of each lower fastening member may be spring-loaded towards its active position and can be displaced to its retracted position against the action of the spring loading to allow the adjacent structural element to enter the hook-shaped member as the frame is moved towards the structural element.

The level of spring loading and shape of the fastening latches of the lower fastening members may be arranged to prevent an operator disengaging these fastening members except when the operator is standing in a safe position below the side frame on the lower level of the associated scaffold structure.

The fastening members adjacent the two upper corners may also be hook-shaped and provided with retractable spring-loaded fastening latches, the level of spring loading and shape of the fastening latches of the fastening members adjacent the two upper corners allowing an operator to disengage these fastening members when the operator is standing in a safe position below the side frame on the lower level of the associated scaffold structure.

The fastening latches adjacent the two upper corners of the side frame can be set to be retained in their retracted positions in which the adjacent structural element can be disengaged.

The fastening members adjacent the two upper corners may each comprise a U-shaped receiving formation, the limbs of each U-shaped formation extending on either side of a vertical or horizontal element of the associated scaffold structure.

Alternatively the fastening members adjacent the two upper corners may each comprise a projecting pin or wedge which engages a pocket carried by a vertical or horizontal element of the associated scaffold structure.

As a further alternative the fastening members adjacent the two upper corners may each comprise a pocket which receives a projecting pin or wedge carried by a vertical or horizontal element of the associated scaffold structure.

Alternatively the fastening members adjacent the two upper corners may each comprise a spring-loaded clamp with jaws which engage a vertical of horizontal element of the associated scaffold structure.

In a further alternative the fastening members adjacent the two upper corners may each comprise a strap which is wrapped around a vertical or horizontal element of the associated scaffold structure.

As a safety feature, the latches adjacent each lower corner of the side frames may be designed to require active pressure on behalf of the operator to hold them in a retracted position for disengagement from the adjacent structural element thus requiring the operator to be on the lower level of the scaffolding.

At least one hook may include a rubber pad which is compressed when the adjacent structural element is retained in the hook to prevent or further enhance the resistance to sideways slipping of the hook relative to the structural element.

The spring loading of the latches of the lower hooks may be arranged to support the weight of the side frame on the latches without the latches being displaced to their retracted position.

Preferably adjacent each upper fastening member the side frame includes a cam member which tends to guide the fastening member into engagement with the adjacent structural element as the side frame is moved towards the element.

The outer end of each hook-shaped fastening member may also include a beak portion with a cam surface to guide the hook over the adjacent structural element as the side frame is moved towards the element.

One or more of the hook-shaped fastening members are preferably oriented with the mouths of the hooks facing downwardly so that the adjacent structural elements are engaged by the hooks by a downward movement of the side frame.

Alternatively one or more of the hook-shaped fastening members are oriented with the mouths of the hooks facing horizontally sideways so that the adjacent structural elements are engaged by the hooks by a twisting movement of the side frame about a generally vertical or horizontal axis.

The side frame preferably has two generally horizontal vertically spaced guard rails which form an upper part of the side frame when the frame is in its operating position and two pairs of downwardly extending side tubes at each end of the horizontal guard rails which form a lower part of the side frame, to give the side frame an inverted U-shaped configuration with an operator access opening in the central lower part of the side frame, the lower ends of each pair of side tubes being joined by respective horizontal lower tubes.

Preferably the inner of each pair of downwardly extending side tubes extends below the respective horizontal lower tube to provide a handhold for the operator to raise the side frame into its operating position.

A bracing member may extend between each lower tube and the outer of each pair of downwardly extending side tubes.

The side frame may have an additional horizontally extending tube at the top of the frame, the additional tube being parallel to and substantially at the same height as the other horizontal tube and being provided to strengthen the frame and to provide an attachment facility for decking elements which extend generally at right angles to the side frame.

An additional vertical strengthening tube may also be provided between the central areas of the horizontal vertically spaced guard rails of the side frame.

The invention also provides a multi-level tower scaffolding comprising a series of end frames, each end frame comprising vertical corner tubes with horizontal end tube members extending between the corner tubes, the end frames being positioned one above each other with decking elements extending between the end frames at a plurality of levels, one or more of the levels of end frames being joined by two side frames as described above.

The fastening members adjacent the corners of the side frames preferably engage the horizontal end tube members of the end frames.

The invention also provides a multi-level scaffolding structure comprising vertical scaffold components connected by generally horizontal scaffold components from which decking elements are supported at different levels in the structure, at least one pair of vertical components of the structure having a side frame in accordance with the first aspect of the invention secured therebetween, the side frame being connected with horizontal scaffold components connected to the pair of vertical components.

The invention also provides a scaffolding structure including one or more tower scaffolding structures as described above in which the towers support a set of formwork beams for supporting concrete casting panels.

The invention further provides a scaffolding structure including two towers with decking elements extended between the towers, the decking elements being supported between side frames having the additional horizontally extending tube as described above.

The invention also provides a method of providing a multi-level tower scaffolding from end frames positioned one above each other, decking elements extending between the end frames and side elements which also extend between the end frames and which provide the necessary guard rails and structural bracing of the tower, at least one level of the scaffolding being constructed by using side frames in accordance with the first aspect of the present invention, one for each side of the tower, said at least one level of scaffolding being constructed by connecting the end frames above the end frames of a lower level of the tower, lifting the side frames into position so that their fastening means engage the end frames of said at least one level by an operator standing on a decking element of the lower level of the tower, and positioning the decking elements of said at least one level between the end frames of said at least one level thus fully completing said at least one level of the scaffolding before the operator climbs on to said at least one level.

The invention still further provides a method of erecting at least part of a multi-level scaffolding structure comprising vertical scaffold components connected by generally horizontal scaffold components from which decking elements are supported at different levels in the structure, the vertical components also being connected by other scaffolding components which provide a guard rail function and complete the structural integrity of the scaffolding structure, said method including the step of erecting at least part of the other scaffolding components using a side frame which extends between an adjacent pair of vertical components of said structure, the side frame being in accordance with the first aspect of the present invention and providing the mandatory guard rail between the adjacent pair of vertical components and being a structural component designed to complete the structural integrity of the structure during the erection and to remain in position throughout the subsequent use of the structure if required, the method including raising the side frame into position and fully engaging the fastening members of the side frame to grip scaffold components of a higher level of the structure using an operator standing on a decking element of a lower level of the scaffolding structure, and positioning the decking elements of the higher level between horizontal scaffold components of the higher level thus fully completing said higher level before the operator climbs to said higher level.

The present invention will now be described, by way of example only, with reference to and as shown in the accompanying drawings:—

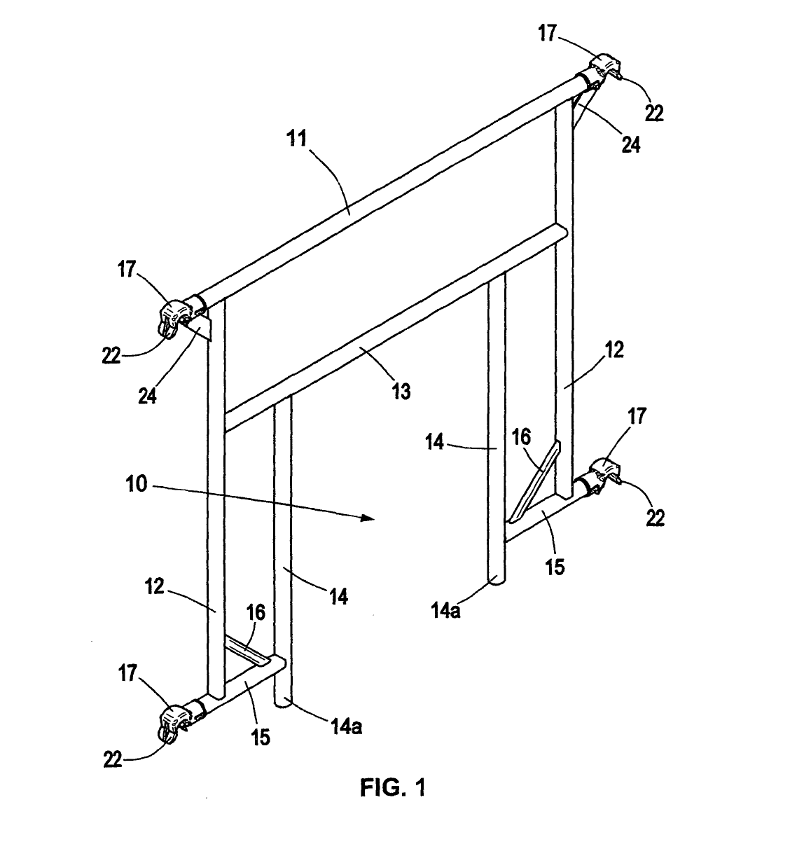

FIG. 1 shows a perspective view of a scaffolding side frame in accordance with the present invention;

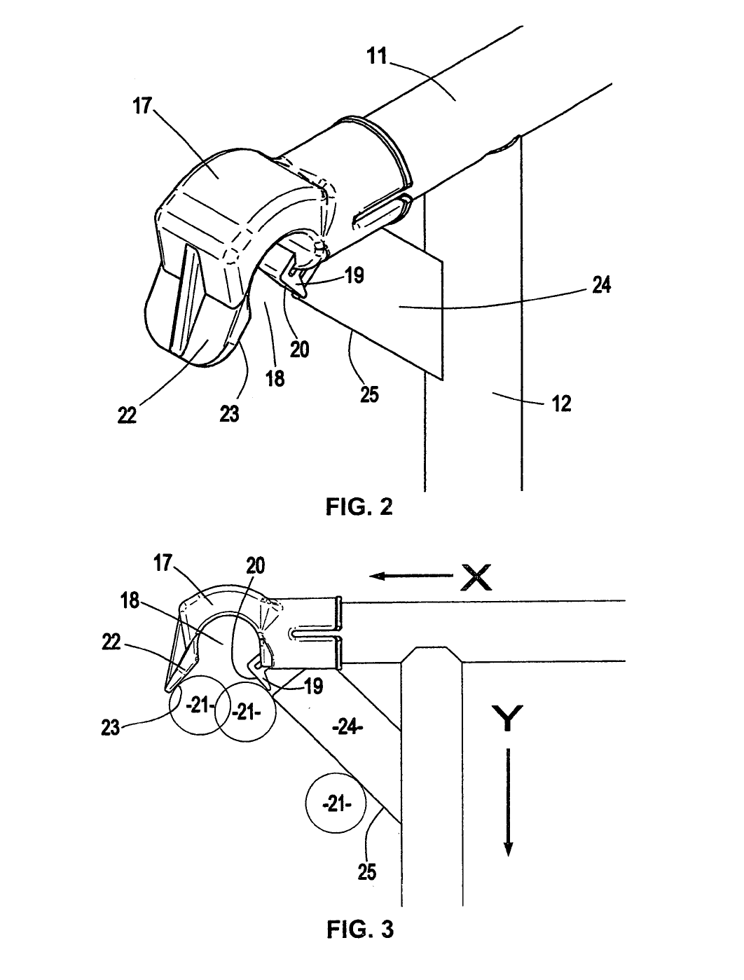

FIGS. 2 and 3 show perspective and side views respectively of a hook-shaped fastening member used in the frame of FIG. 1;

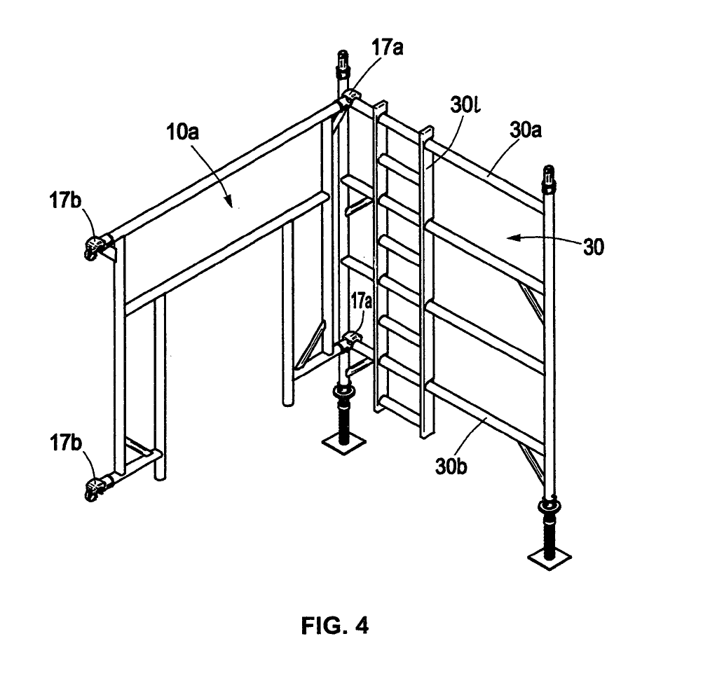

FIGS. 4 to 8 show various stages in the erection of a first level of a tower scaffolding using side frames as shown in FIG. 1;

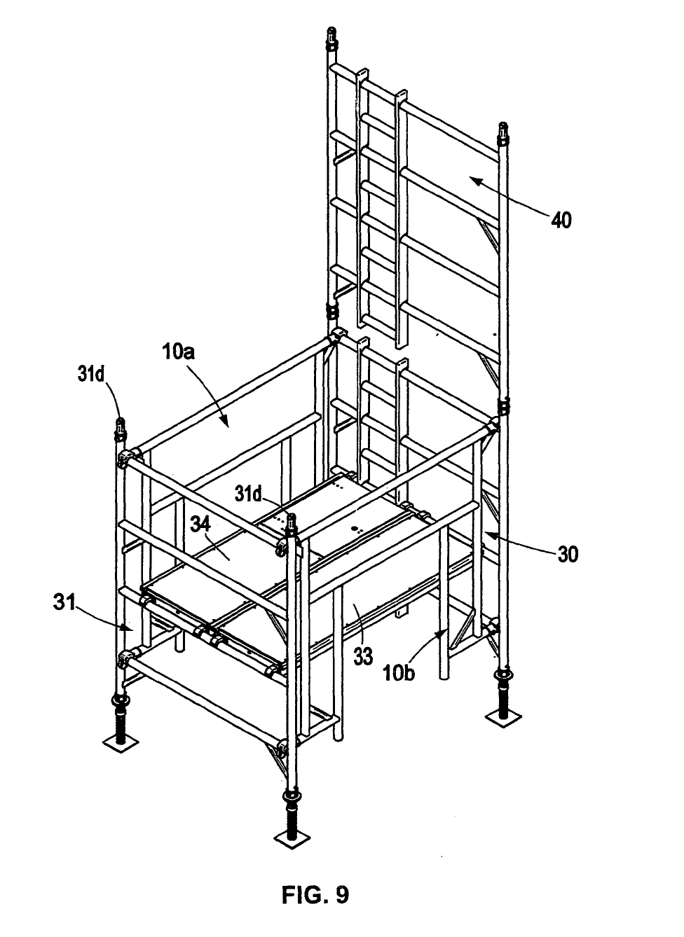

FIGS. 9 to 13 show various stages in the erection of a second level of a tower scaffolding using side frames as shown in FIG. 1;

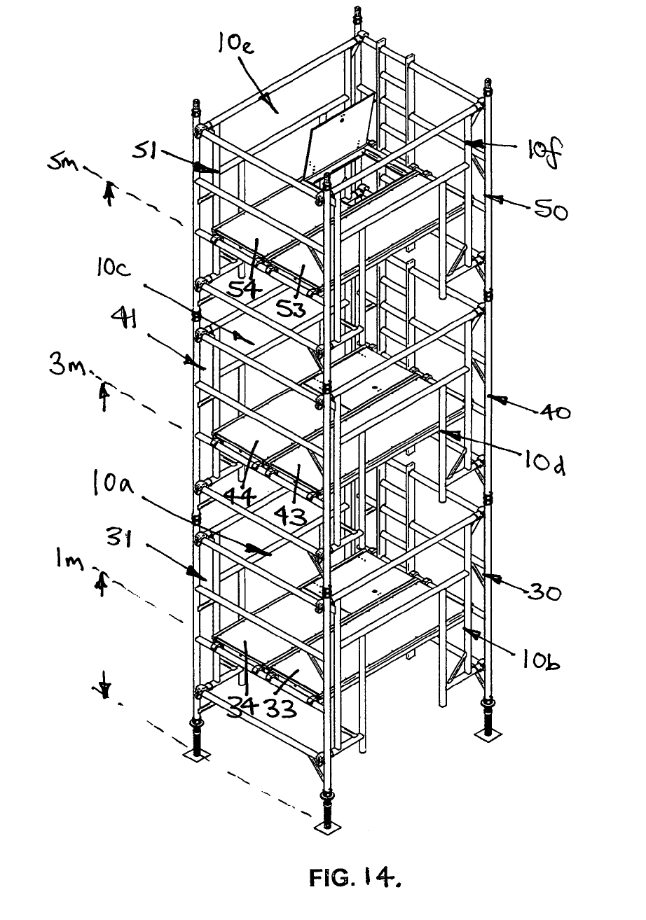

FIG. 14 shows a three level tower scaffolding constructed using side frames as shown in FIG. 1;

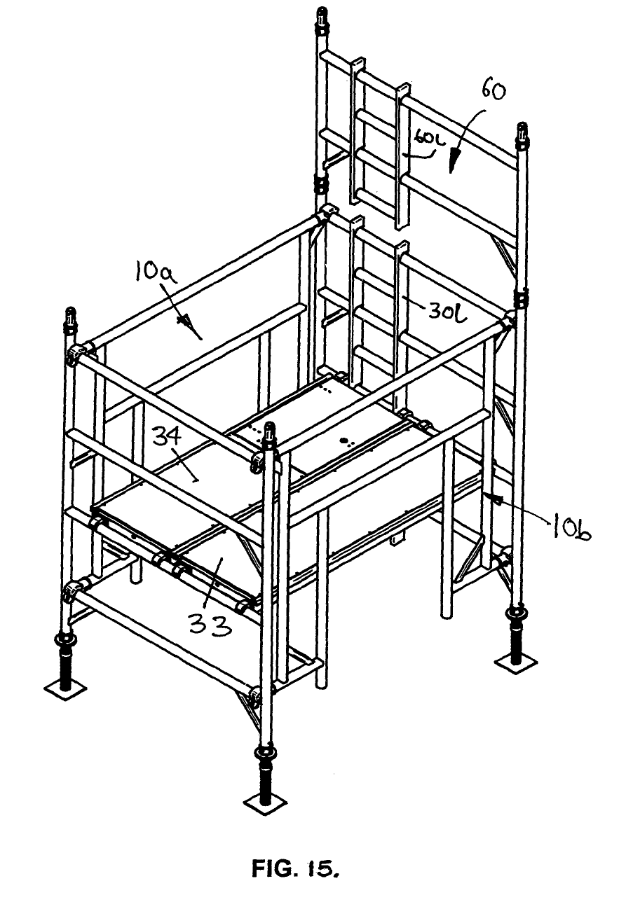

FIGS. 15 to 17 show the erection of a half height level of scaffolding to enable the decking elements of the scaffolding to be located at different heights;

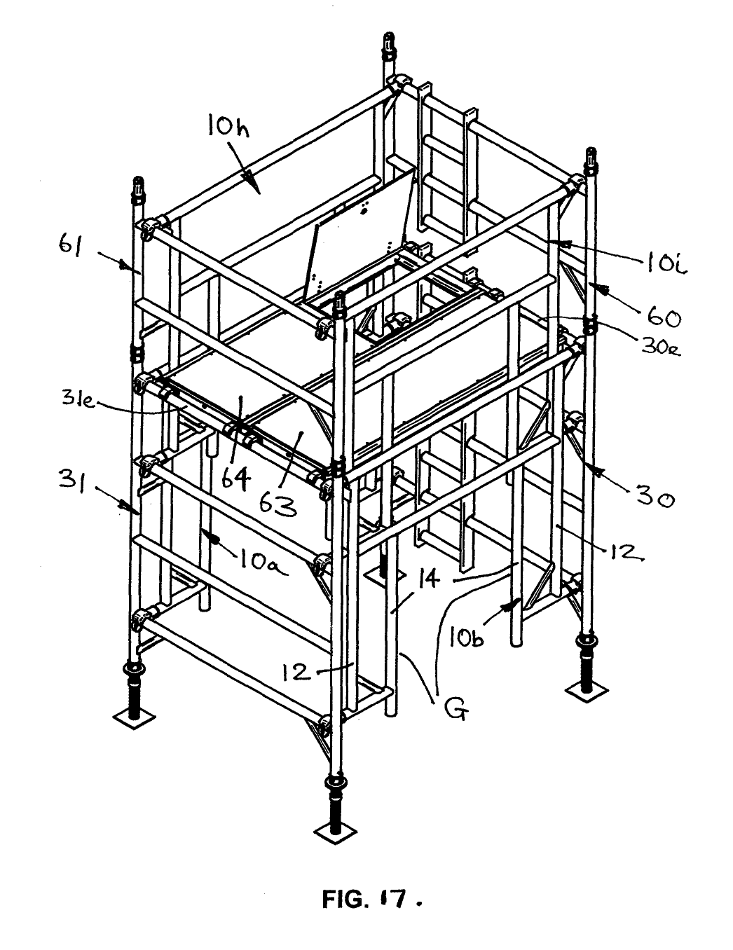

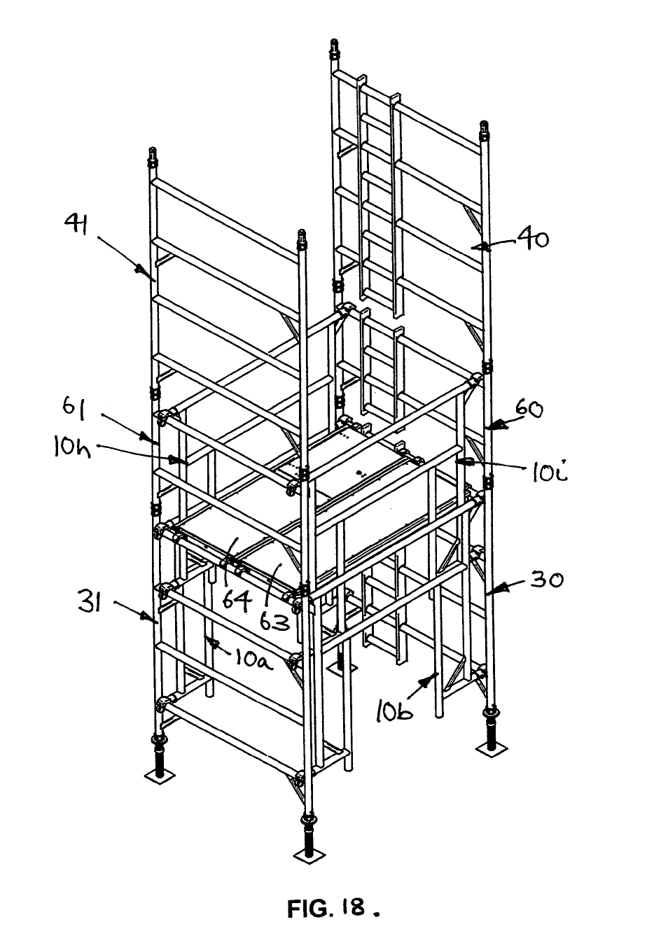

FIGS. 18 to 21 show the erection of additional levels of scaffolding on the scaffolding of FIG. 17;

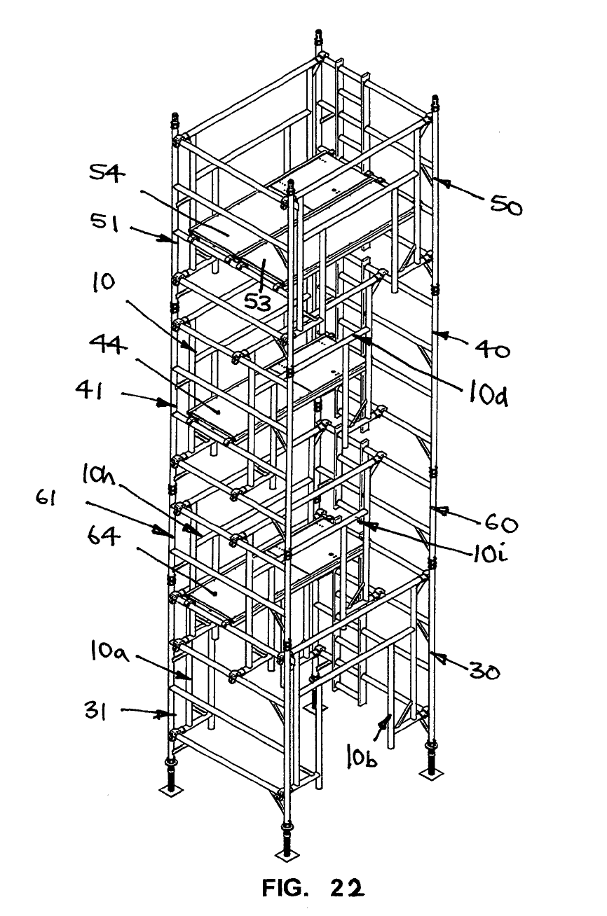

FIG. 22 shows a tower scaffolding with half width decking elements at lower levels and side frames in the centre of the tower;

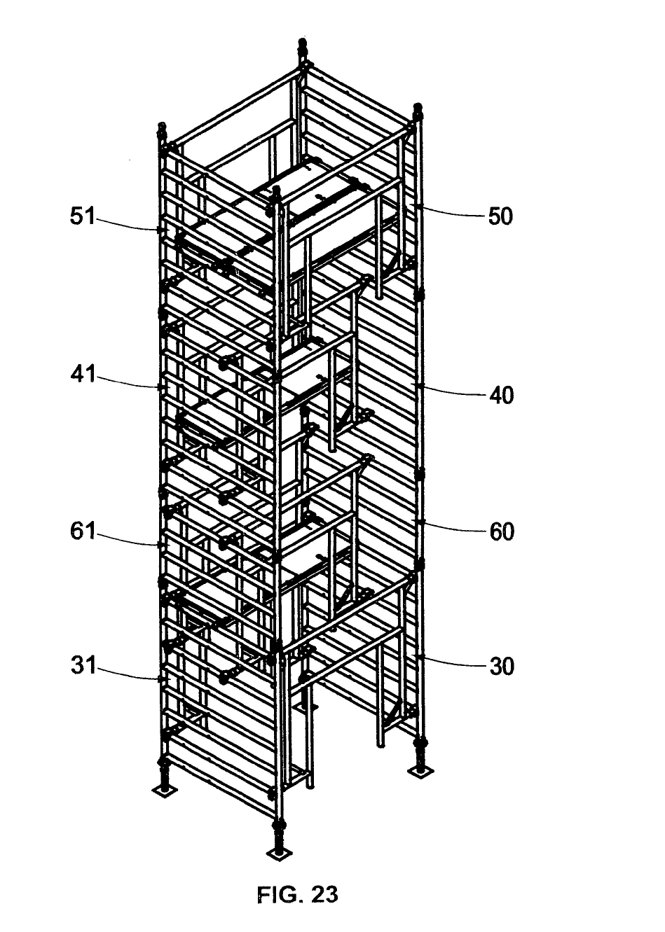

FIG. 23 shows a tower scaffolding with 0.25 m vertically spaced horizontal tubes in its end frames to provide a ladder function;

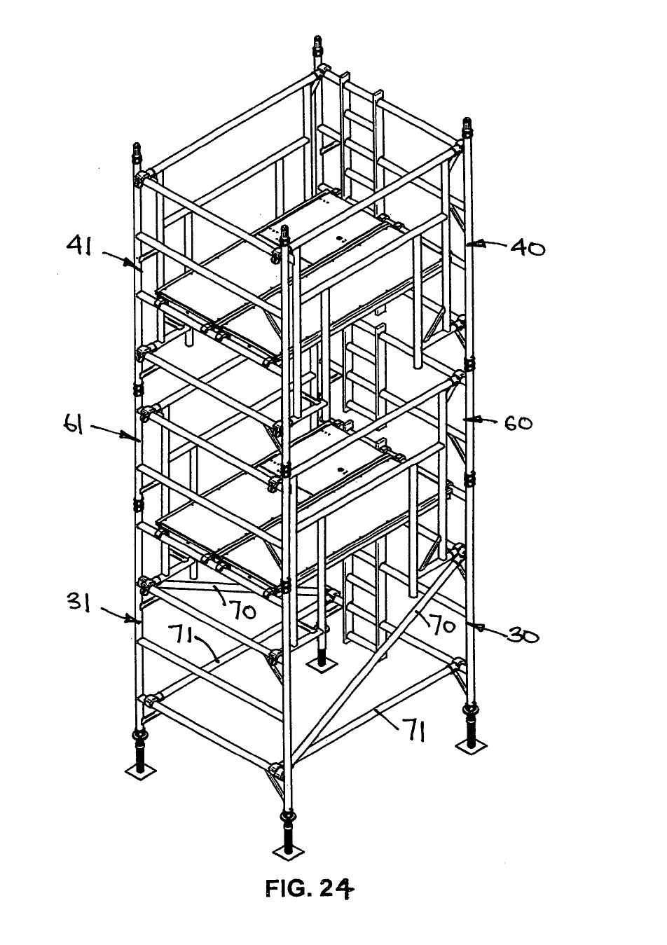

FIG. 24 shows how the first level side frames can be replaced by horizontal and diagonal bracing tubes;

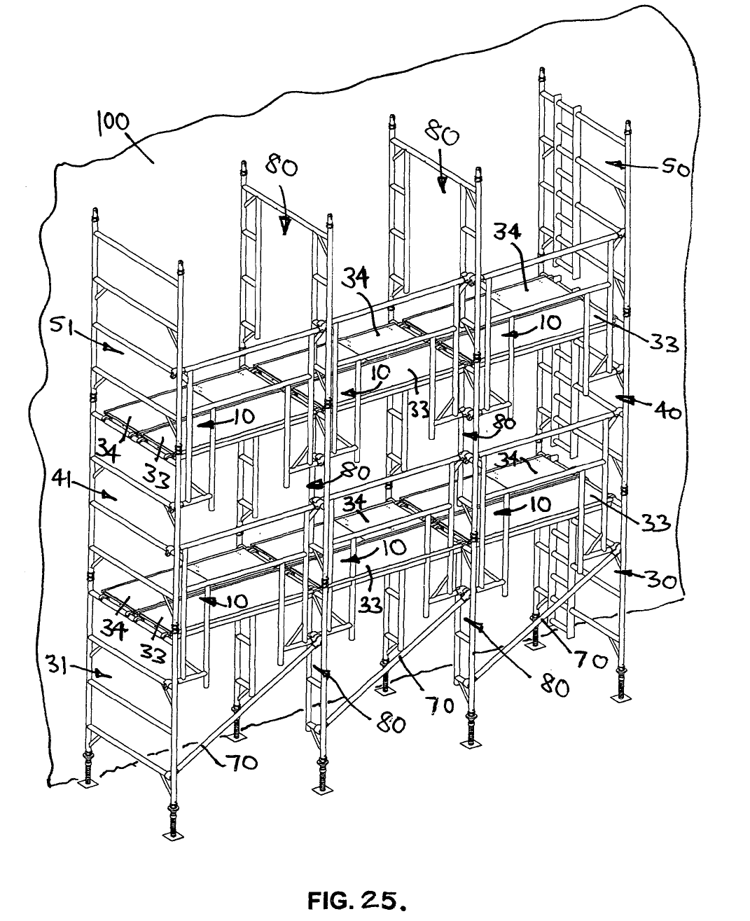

FIG. 25 shows how the side frame of the present invention can be used in a façade scaffolding structure, and

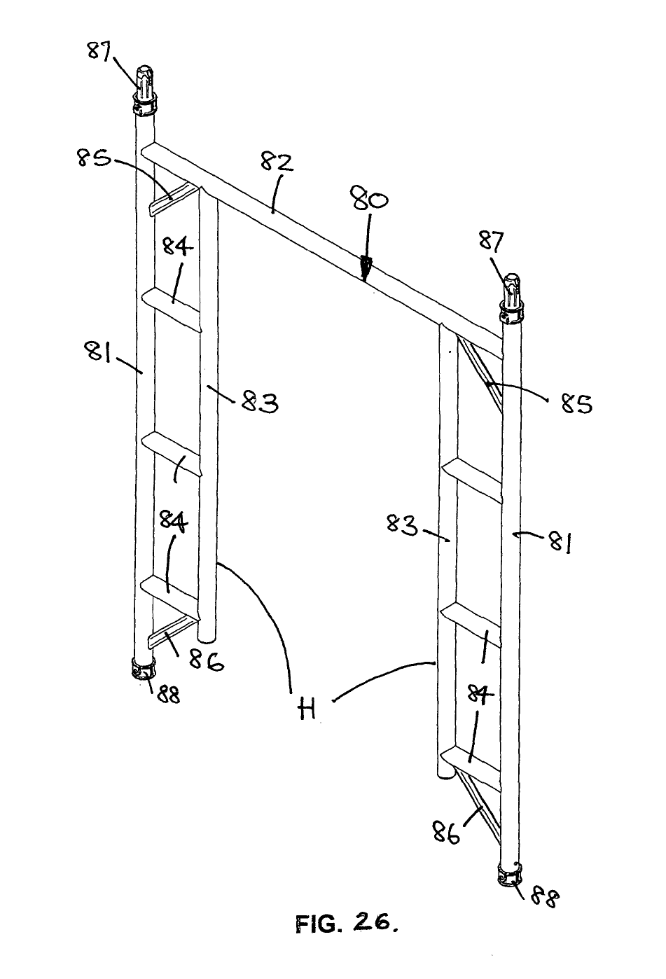

FIG. 26 shows a walk-through frame used in the façade scaffolding of FIG. 25;

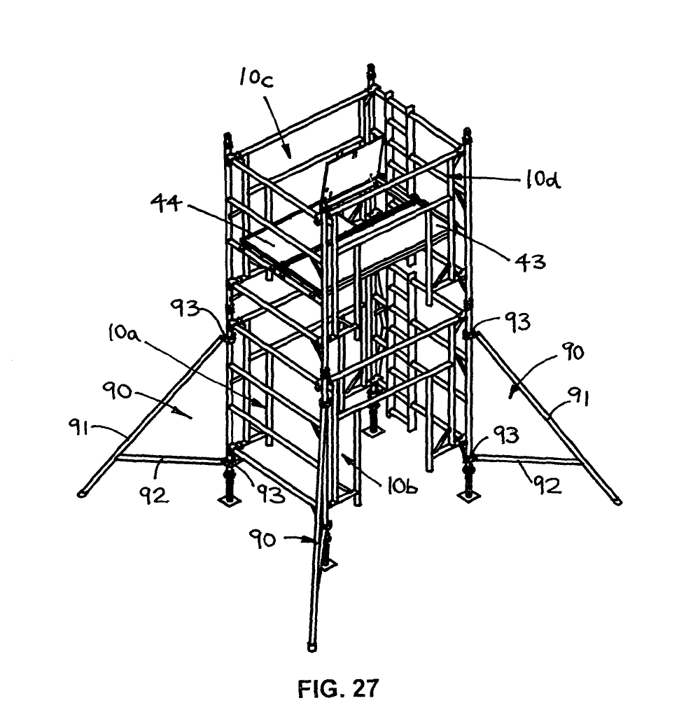

FIG. 27 shows a tower scaffolding with corner stabilizers;

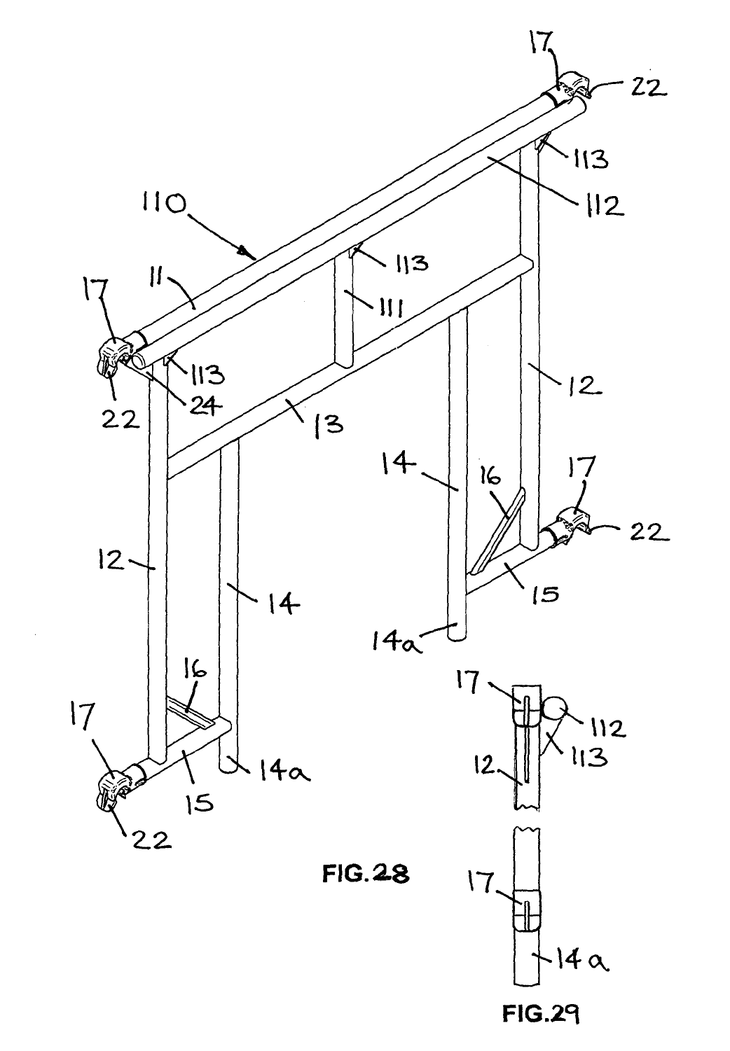

FIG. 28 shows a perspective view of a strengthened side frame in accordance with the present invention which is used to bridge two towers with decking elements;

FIG. 29 shows an end view of the side frame of FIG. 28;

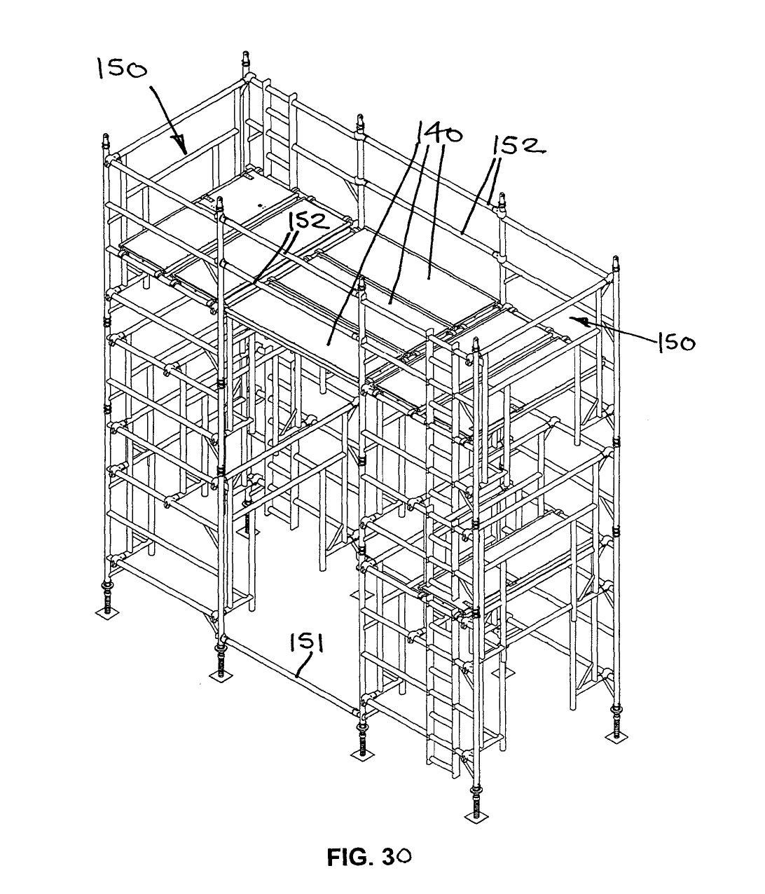

FIG. 30 shows a perspective view of two tower scaffolds which use side frames in accordance with the present invention bridged by decking elements;

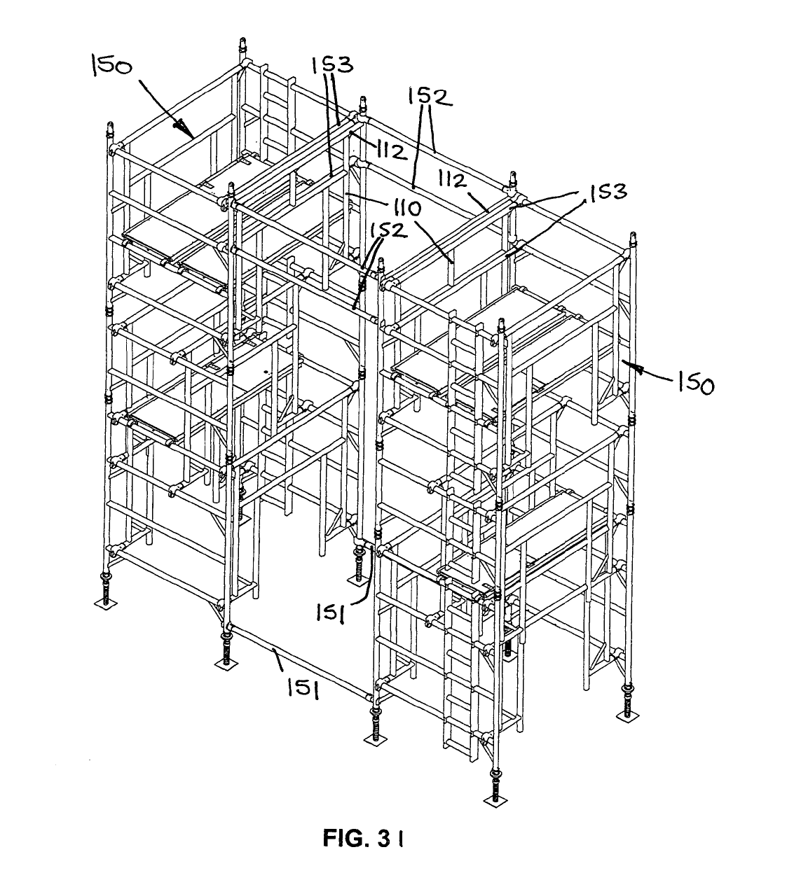

FIGS. 31 to 33 show stages in the construction of the scaffolding structure of FIG. 30;

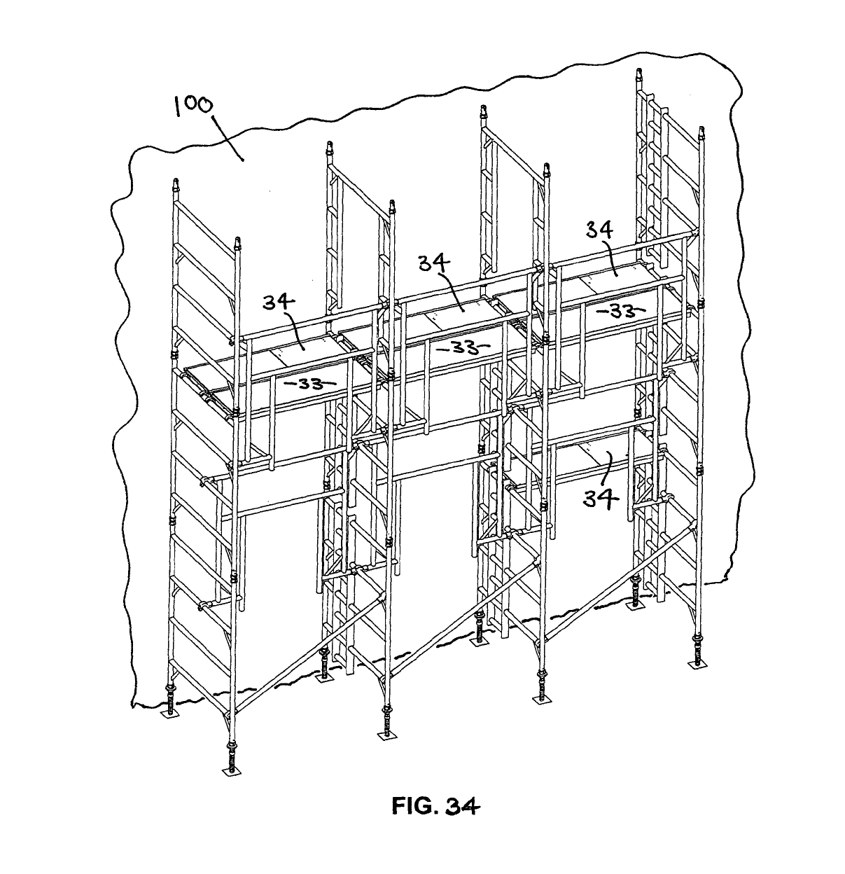

FIG. 34 shows the façade scaffolding structure of FIG. 25 with the lower decking elements removed in all but one bay of the structure;

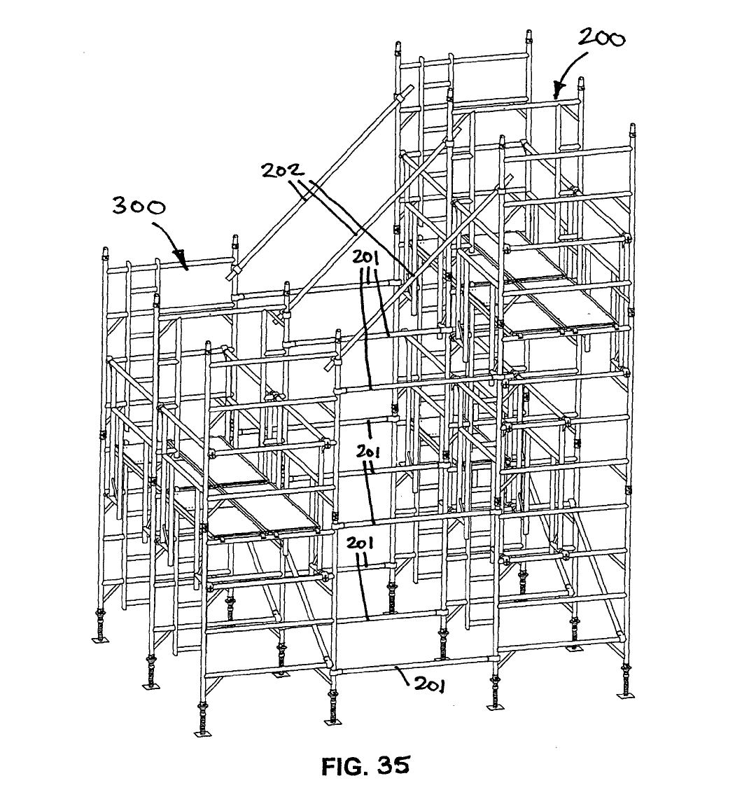

FIG. 35 shows a main façade scaffolding structure constructed using side frames in accordance with the present invention stabilised by a smaller adjacent scaffolding structure;

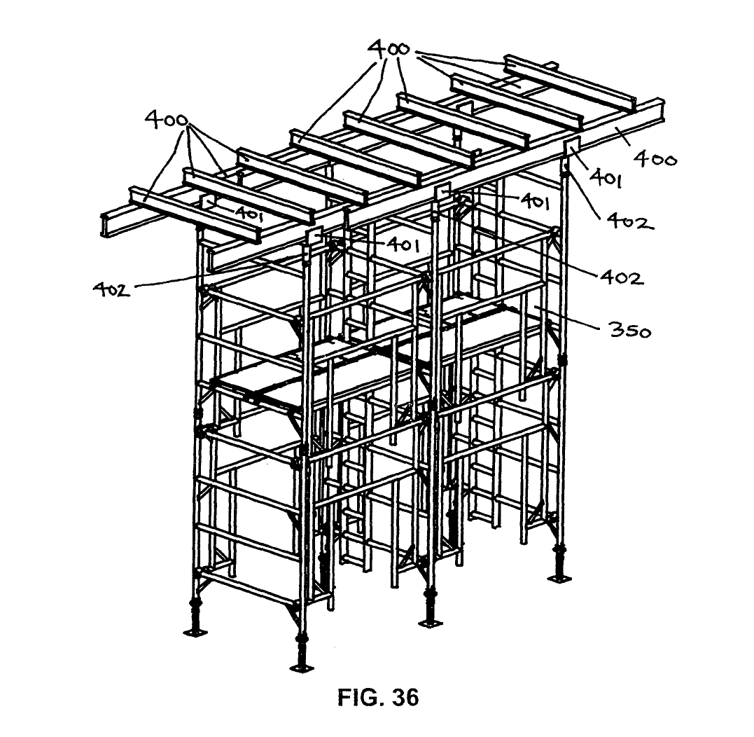

FIG. 36 shows a falsework or shoring structure constructed using side frames in accordance with the present invention used to support formwork beams for supporting concrete casting panels;

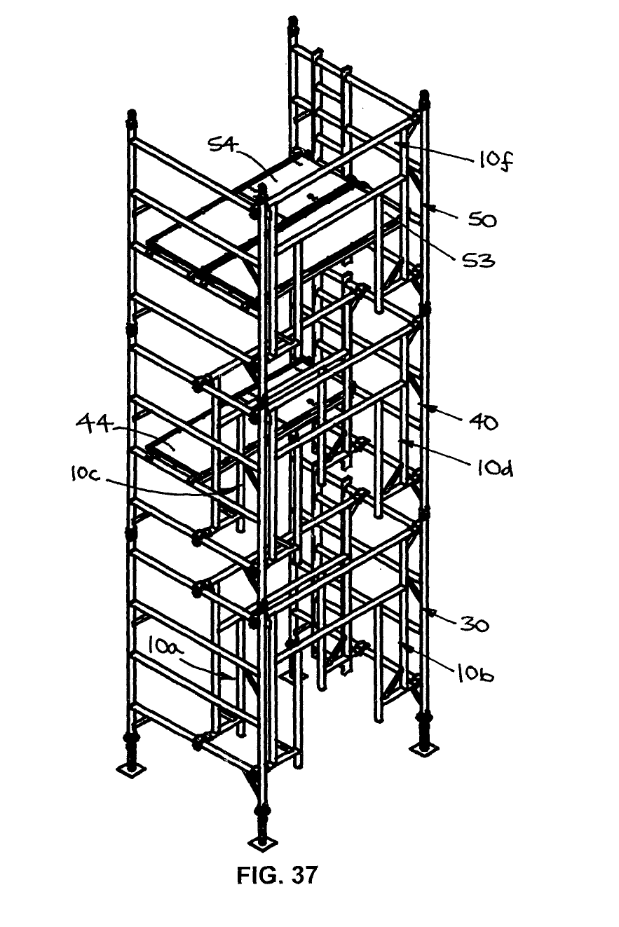

FIG. 37 shows a façade tower structure with half width decking elements and side frames in the centre of the structure;

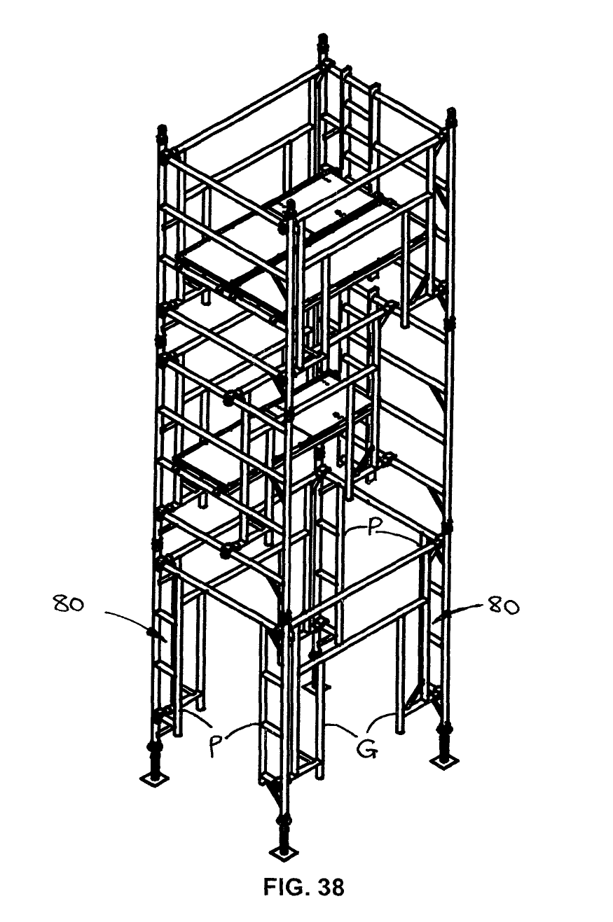

FIG. 38 shows a tower structure with walk through end frames on the ground level;

FIG. 39 shows a rubber pad fitted inside the hook used to secure a side frame in accordance with the present invention to its associated horizontal scaffold member;

FIGS. 40 to 42 show details of the operation of the latches used on the two lower attachment hooks of a side frame in accordance with the present invention;

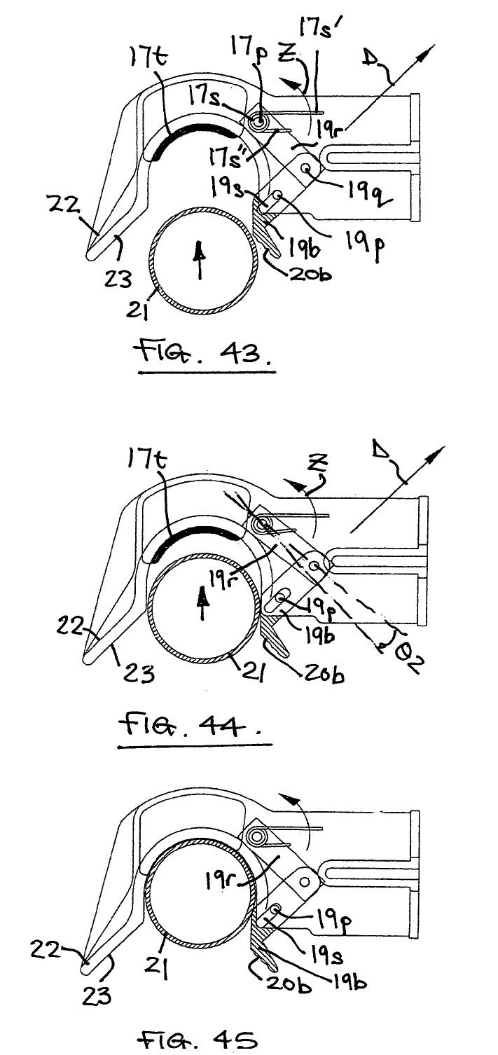

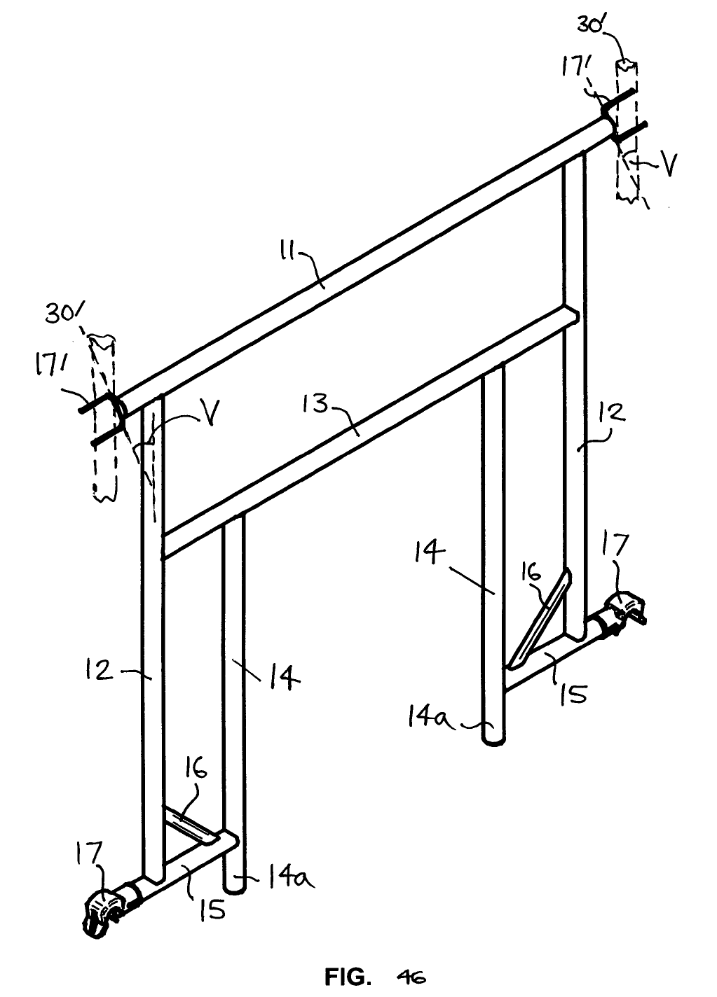

FIGS. 43 to 45 show details of the operation of the latches used on the two upper attachment hooks of a side frame in accordance with the present invention, and

FIGS. 46 to 51 show details of alternative upper and lower fastening members which can be used on the side frame.

Referring to FIGS. 1 to 3 of the drawings, a scaffolding side frame 10, which is constructed from aluminium tubing, has an upper horizontal tube 11 and two side tubes 12 depending therefrom. A second horizontal tube 13 extends between the side tubes 12 and inner vertical tubes 14 depend from the second horizontal tube 13. Horizontal lower tubes 15 extend between the side tubes 12 and the inner tubes 14 and the inner tubes 14 have lower portions 14a which extend below the lower tubes 15 and provide a handhold for a scaffolding operator. A bracing member 16 extends between each lower tube 15 and the associated side tube 12 to stiffen the side frame structure.

At each corner of the side frame an aluminium fastening member 17 is provided which is hook-shaped. Each hook-shaped member has a mouth 18 through which a generally horizontally extending scaffolding tube indicated diagrammatically at 21 in FIG. 3 can be engaged as will be described below. Adjacent each mouth 18 is a spring biased latch 19 which, as can be best seen from FIG. 3, has a cam surface 20 which when contacted by the horizontal scaffolding member 21 is moved from its active position shown in FIG. 3 to a retracted position allowing the scaffolding member 21 to move through the mouth 18 into the hook-shaped member 17, whereupon the latch 19 springs back to grip and retain the scaffolding member 21 in the hook-shaped fastening member.

Also, the outer end of the hook-shaped member 17 has a beak-shaped portion 22 which includes a cam surface 23 which deflects the side frame relative to the scaffolding member 21 in the direction of the arrow X of FIG. 3 as the side frame is moved downwardly indicated by the arrow Y thus ensuring that the scaffolding member 21 enters the mouth 18 of the hook-shaped fastening member 17 when the side frame 10 is being attached to the remainder of the scaffolding.

Adjacent each of the upper hook-shaped fastening members 17 a cam member 24 is provided whose cam surface 25 also tends to deflect the side frame in the opposite direction to the arrow X of FIG. 3 as the side frame is moved downwardly indicated by the arrow Y thus ensuring that the scaffolding member 21 enters the mouth 18 of the hook-shaped fastening member 17 when the side frame 10 is being attached to the remainder of the scaffolding.

Having briefly described the constructional details of the side frame the use of the side frame in the construction of a tower scaffolding will now be described.

FIG. 4 shows a tower scaffolding end frame 30 to which a side frame 10a has been attached by its fastening members 17a via its horizontal tubes 30a and 30b. As can be seen, the end frame 30 includes ladder section 30 and can be conveniently constructed in accordance with the Applicant's co-pending UK patent application no. GB2441767A.

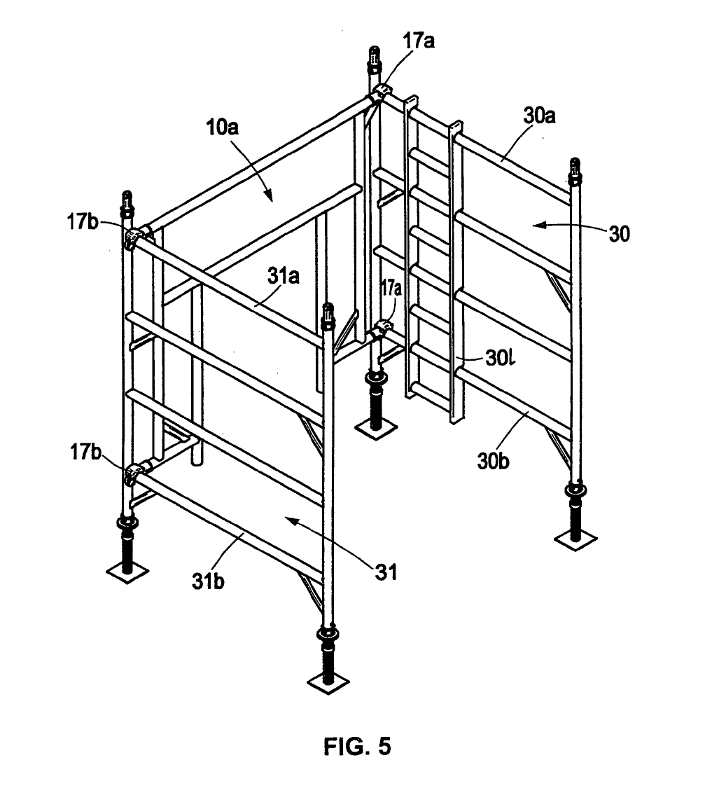

In FIG. 5 a second end frame 31 is attached to the side frame 10a using the hook-shaped fastening members 17b which hook over the horizontal tubes 31a and 31b.

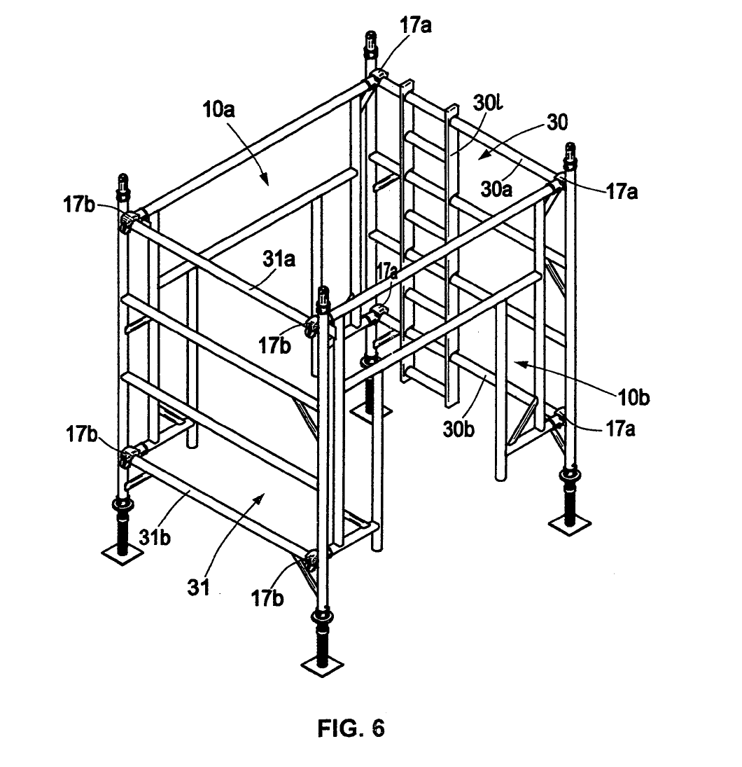

FIG. 6 shows the attachment of a second side frame 10b between the end frames 30 and 31 using the hook-shaped fastening members 17a and 17b of the second side frame 10b. The side frame 10b is manoeuvred into position by twisting the side frame about a generally vertical axis so that the fastening members 17a and 17b are above the horizontal tubes 30a, 30b, 31a, 31b and then moving the frame downwardly so that the fastening members engage the horizontal tubes.

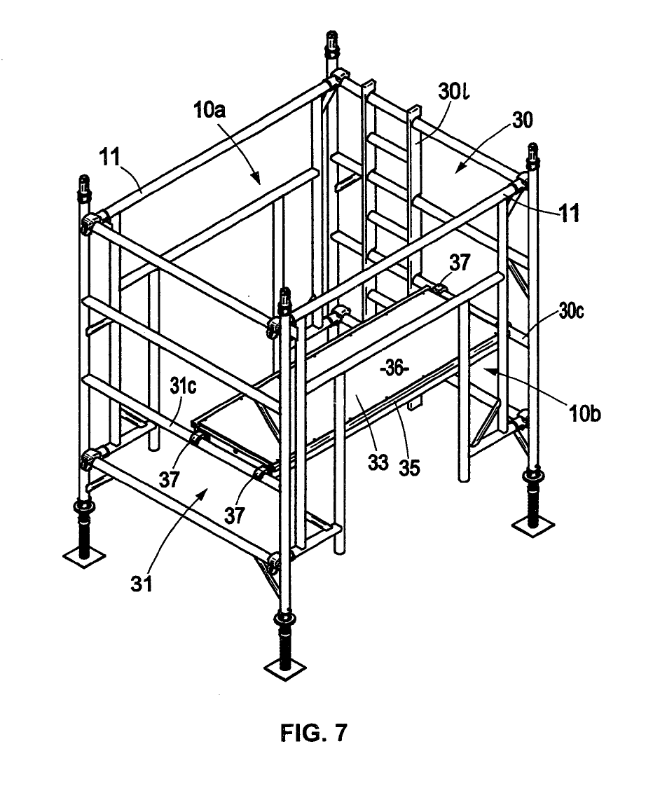

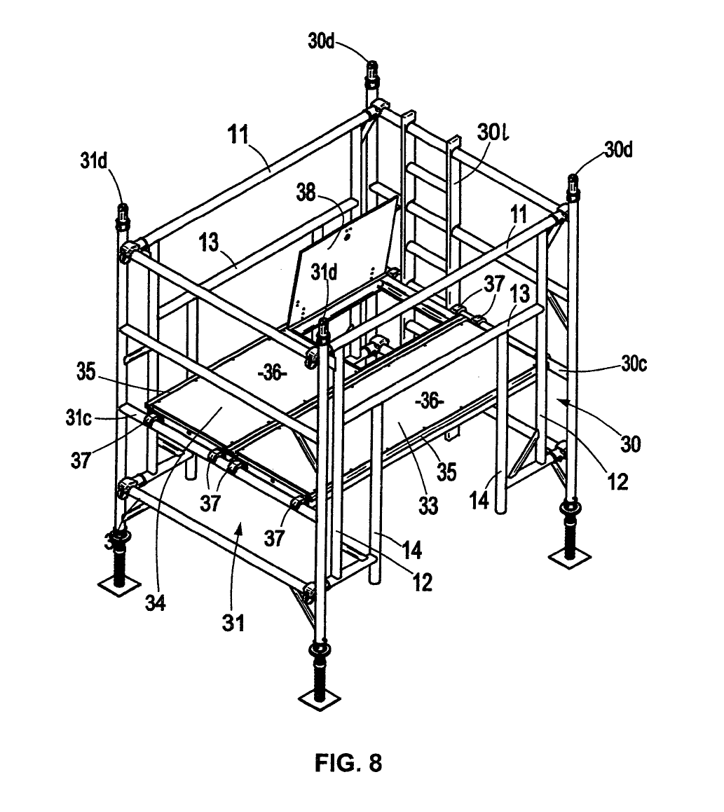

The first level of the tower scaffolding is completed as shown in FIGS. 7 and 8 by the addition of decking elements 33 and 34 which each comprise outer rectangular aluminium frames 35 and plywood or metal decking members 36. The outer frames 35 are provided with hooks 37 which hook over one of the horizontal bars 30c, 31c of the end frames 30 and 31 respectively. As is shown in FIG. 8, the decking element 34 has a trap door 38 through which a scaffolding operator can climb onto the decking elements 33 and 34.

As can be seen from FIGS. 7 and 8 no additional bracing members are used to complete the first level of the tower scaffolding. Side frames 10a and 10b are full structural elements of the tower and form the only connection between the end frames 30 and 31 (except the decking elements 33 and 34) and also provide all the required mandatory guard rail protection via tubes 11 and 13 which are located at 1 metre and 0.5 metres above the decking elements 33 and 34.

As will be appreciated, the construction of the first level of the tower scaffolding can be completed by an operator standing on the ground. Thus before the operator climbs on to the decking elements 33 and 34 to erect the higher levels of the scaffolding all the mandatory guard rail protection is in place.

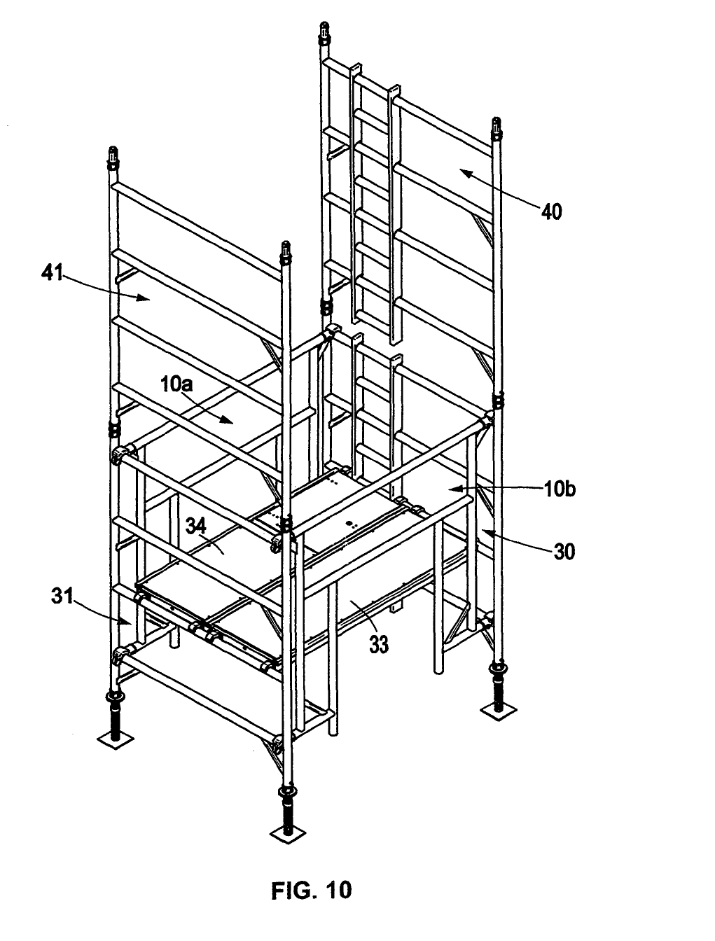

FIGS. 9 and 10 show the start of the erection of the second level of the tower scaffolding in which the end frames 40 and 41 are placed over the spigots 30d and 31d of the lower level end frames 30 and 31 by an operator standing on the decking elements 33 and 34.

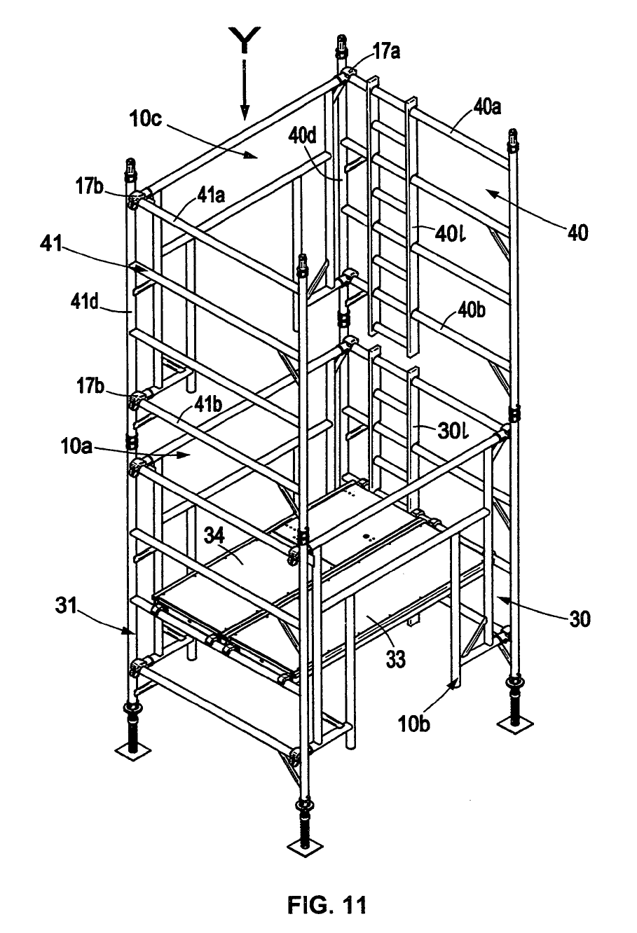

Next, as shown in FIG. 11, a side frame 10c is connected between the end frames 40 and 41 using the fastening member 17a and 17b of the side frame 10c.

In accordance with the present invention this side frame 10c is connected with the end frames 40 and 41 by an operator standing on the decking elements 33 and 34 and raising the side frame 10c upwardly until the connecting members 17a and 17b are above their respective tubes 40a, 40b and 41a, 41b whereupon the operator moves the side frame downwardly as indicated by the arrow Y in FIG. 11 thus causing the hook-shaped fastening members to engage the horizontal tubes 40a, 40b, 41a and 41b. As will be appreciated, in order to get the side frame 10c into a position in which it can snap on to the end frame tubes 40a, 40b, 41a and 41b it is necessary to thread the side frame inside the vertical tubes 40d and 41d of the end frames.

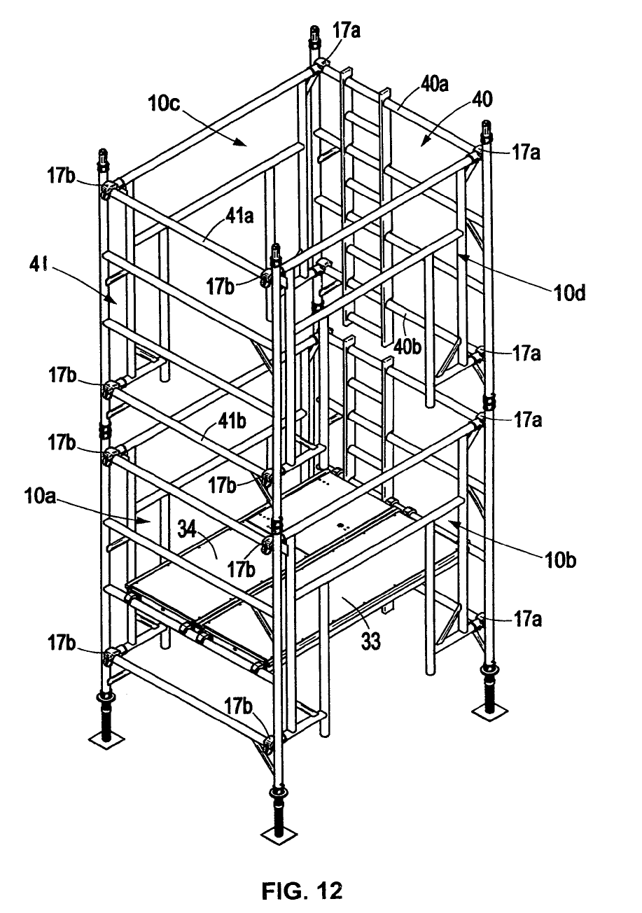

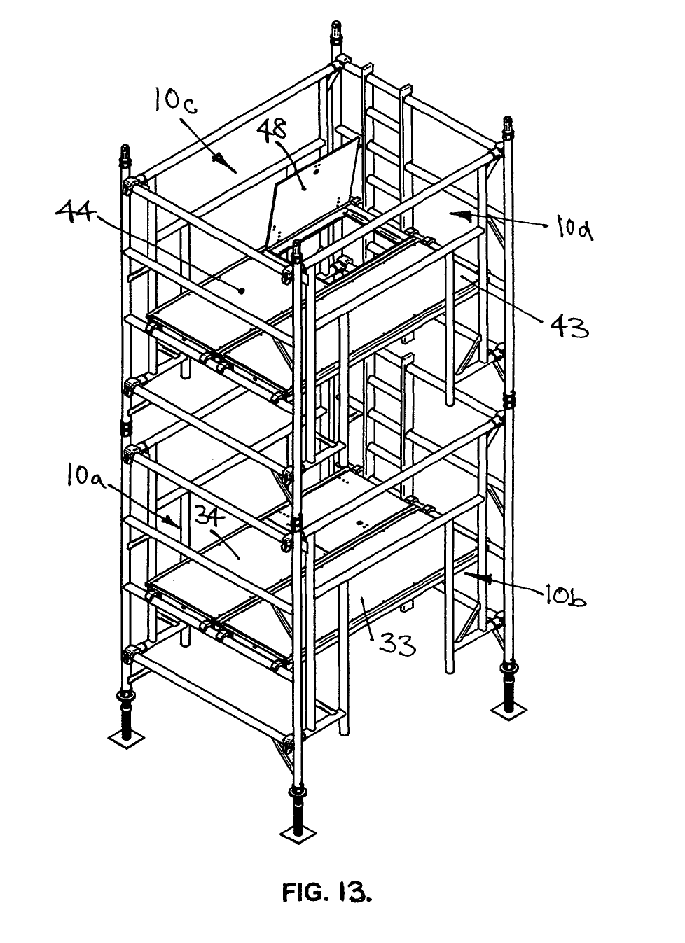

In a similar manner, as shown in FIG. 12, a further side frame 10d is connected between the other ends of the end frames 40 and 41 by an operator standing on the decking elements 33 and 34. The second level of decking elements 43 and 44 is then added to complete the second level of the tower scaffolding as shown in FIG. 13. The decking element 44 again includes a trap door 48 for access to the decking elements 43 and 44.

As previously indicated in relation to the first level of the tower scaffolding the second level of the tower scaffolding is constructed solely from the end frames 40 and 41 and the two side frames 10c and 10d together with the decking elements 43 and 44. Thus the side frames 10c and 10d are again full structural elements of the tower and provide all the required mandatory guard rail protection for an operator working on the second level of decking elements.

As will be appreciated, since the two side frames 10c and 10d can be fully engaged with the end frames 40 and 41 by an operator standing on the first level of decking elements 33 and 34, the second level of the tower scaffolding can be fully completed structurally and all the necessary mandatory guard rail protection can be in place before the operator climbs up to the second level of the decking elements 43 and 44. Thus the operator is fully protected before he climbs to the second level of the scaffolding.

As shown in FIG. 14, the scaffolding can be continued further vertically to include, for example, a third level having end frames 50, 51, side frames 10e, 10f and decking elements 53 and 54 as shown in FIG. 14. In FIG. 14 the decking elements 33, 34, 43, 44 and 53, 54 are provided at heights of one metre, three metres and five metres respectively above the ground level since the vertical spacing between the horizontal tubes of the end frames is typically 0.5 metres.

For safety reasons the latches 19a of the two hooks 17 adjacent the lower corners of the side frame 10 of the present invention are designed so that these lower latches can only be disengaged when the operator is standing in a safe position below the side frame on a lower level of the associated scaffold structure. FIGS. 40 to 45 show one way in which such a latch design could be achieved.

FIGS. 40 to 42 show the configuration adapted for the latches 19a of the two lower hooks of each side frame and FIGS. 43 to 45 show the configuration adopted for the latches 19b of the two upper hooks of each side frame.

In FIGS. 40 to 42 each lower latch 19a has a slot 19s which slides on a fixed pin 19p. Latch 19a is pivoted at 19q to an arm 19r which is pivotally mounted on the hook 17 by a pin 17p. A spring 17s surrounds pin 17p and one end 17s′ of spring 17s bears against the inside of hook 17 whilst the other end 17s″ of spring 17s bears against arm 19r. Thus, as latch 19a is pressed in direction D by the scaffolding tube 21 which it is attempting to engage, the arm 19r pivots anti-clockwise as indicated by the arrow Z and the spring 17s is placed under further torsional load.

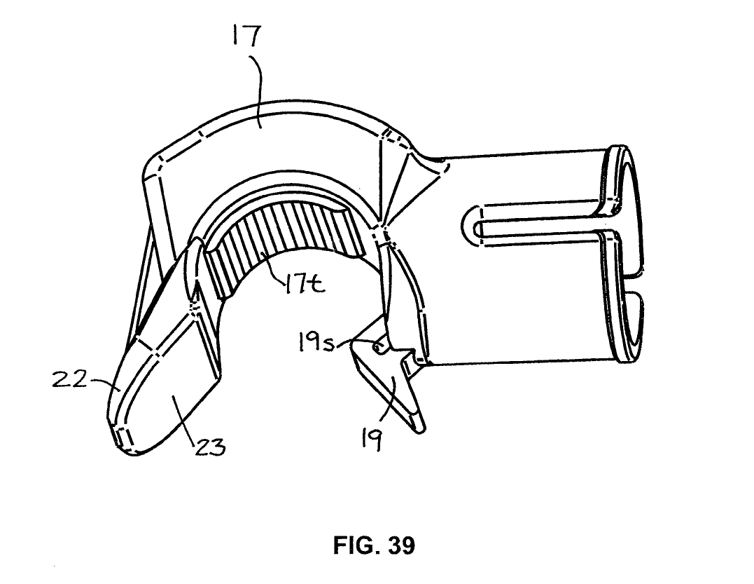

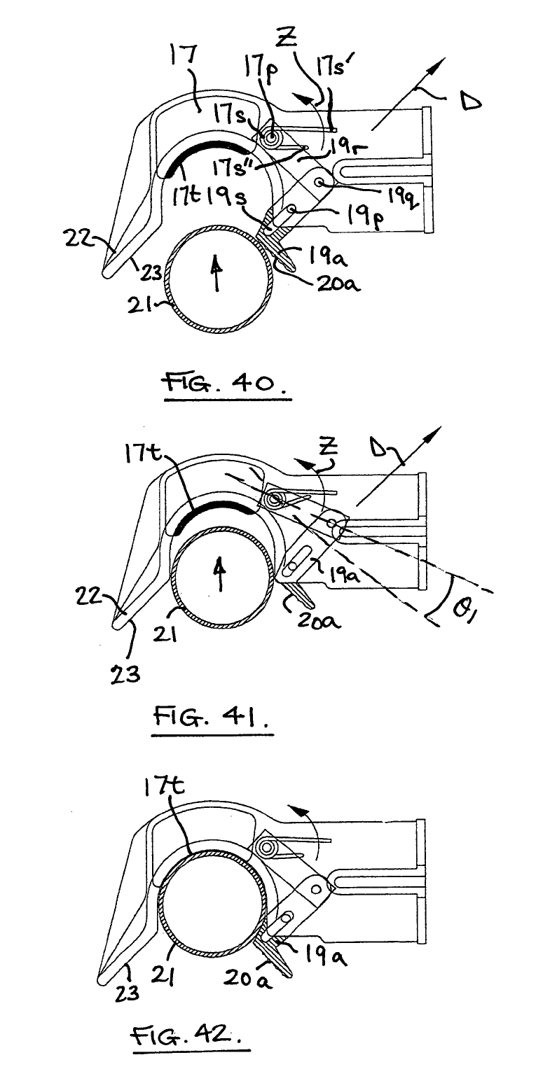

The shape of the cam surface 20a of latch 19a is also designed to require a relative large angular rotation θ1 (see FIG. 41) of arm 19r (and hence high torsional loading of spring 17s) in order for the scaffolding tube 21 to be able to enter the mouth 18 of the lower hook 17. The hook 17 is also provided with a rubber pad 17t which may be several mm thick and which is squashed between the hook and the tube 21 when the tube is fully engaged in the hook 17 and the latch 19a has extended to hold the tube 21 in the hook as is shown in FIG. 42. The rubber pad 17t stops or further enhances the resistance to the side frame slipping sideways relative to the horizontal scaffolding tube 21 on which it is supported by the hooks 17.

In some circumstances only the upper hooks 17 may be provided with the pads 17t or none of the hooks may have the pads if the friction between the hooks and the end frame bars is considered to be sufficient to prevent sideways slipping.

In the upper latch arrangement shown in FIGS. 43 to 45, the upper cam surface 20b of the latch 19b provides less interference to the passage of the scaffolding tube 21 into the mouth of the upper hook 17 so that the angular rotation of the arm 19r is smaller and hence the resistance provided by spring 17s is lower. Also the spring 17s associated with the upper latch 19b can be weaker than the spring associated with the lower latch. Thus the operator is required to apply less force to disengage the upper hooks from their associated horizontal scaffold tubes 21 and can disengage the upper hooks when standing on a level of scaffolding below the side frame.

Additionally the spring force of spring 17s associated with the lower latch is arranged to be sufficient to prevent the weight alone of the side frame 10 displacing the lower latch 19a sufficiently to allow the scaffolding tube 21 to enter the mouth of the lower hook so that, when the operator has moved the side frame vertically upwards to disengage one lower hook 17 and the upper hook at one end of the side frame, he can move to the other end of the side frame to disengage the other lower and upper hooks without the side frame reengaging the associated horizontal scaffold tubes under its own weight.

Thus the operator when standing on a level of the scaffolding below the side frame can apply sufficient force to the side frame to disengage both the lower and upper hook latches but is unable to disengage both these latches when standing on a higher level of the scaffolding where the side frame is providing the mandatory safety rail protection.

In an alternative arrangement the latches of the upper hooks of the side frame can be set to be retained in their retracted positions so that the adjacent structural element can be disengaged. This can be done when the operator is standing on a higher level of the scaffolding structure before he descends to a lower level. As a safety measure the latches adjacent each lower corner of the side frame can be arranged to require active pressure on behalf of the operator to hold them in a retracted position for disengagement from the adjacent structural element thus requiring the operator to be on the lower level of the scaffolding. The operator is thus not able to demount the side frame unless he is standing on the lower level of the scaffolding.

If it is desired to construct a tower with decking elements at different heights, for example, at two metres, four metres and six metres above the ground level the construction procedure shown in FIGS. 15 to 24 may be employed.

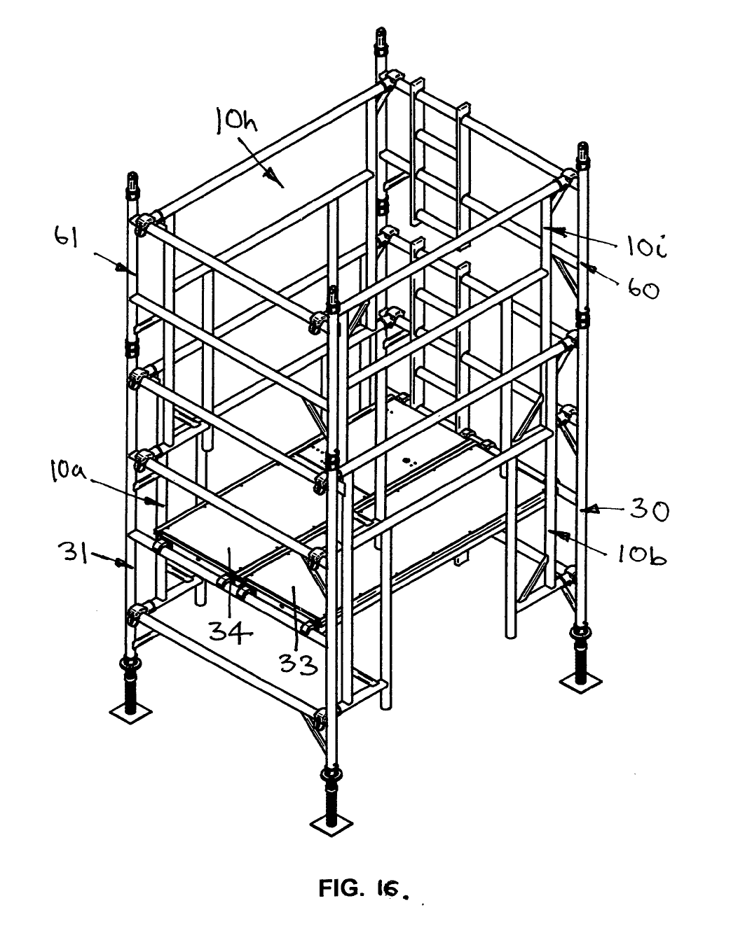

FIG. 15 shows the first stage of the scaffolding tower constructed in the same manner as previously described with reference to FIGS. 4 to 8. With the operator standing on decking elements 33 and 34 he erects half height end frames 60 and 61 as shown in FIGS. 15 and 16. He then adds the side frames 10h and 10i which, as can be seen from FIG. 16 partially overlap the side frames 10a and 10b of the first level of the tower scaffold. Decking elements 33 and 34 are then moved to a higher level where they are designated as decking elements 63 and 64 and are supported from the top bars 30e and 31e of end frames 30 and 31 as shown in FIG. 17. FIG. 17 also shows the benefits of the gap G in the side frames between the inner tubes 14 since this gap provides easy access for the operator through the side frames to the space beneath the decking elements 63 and 64.

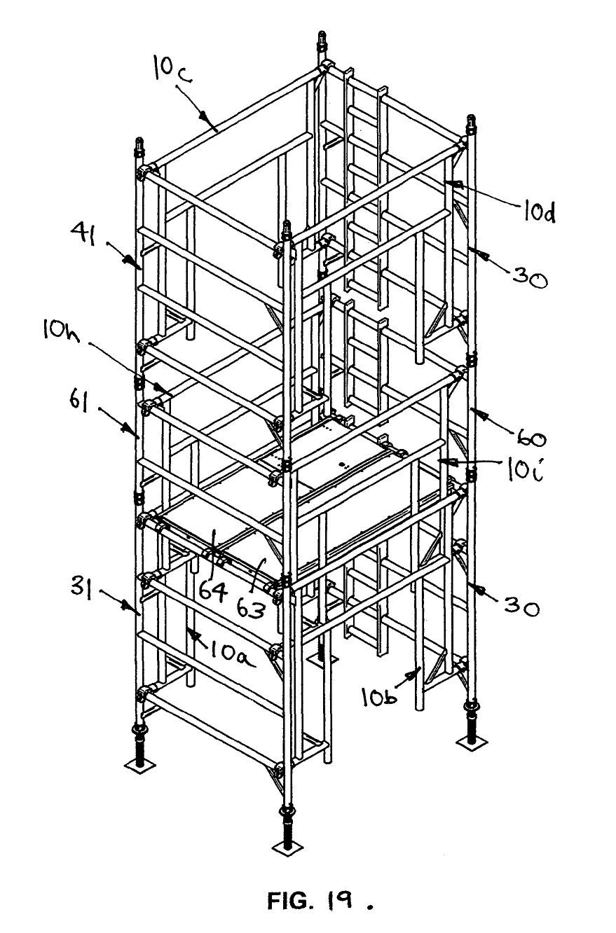

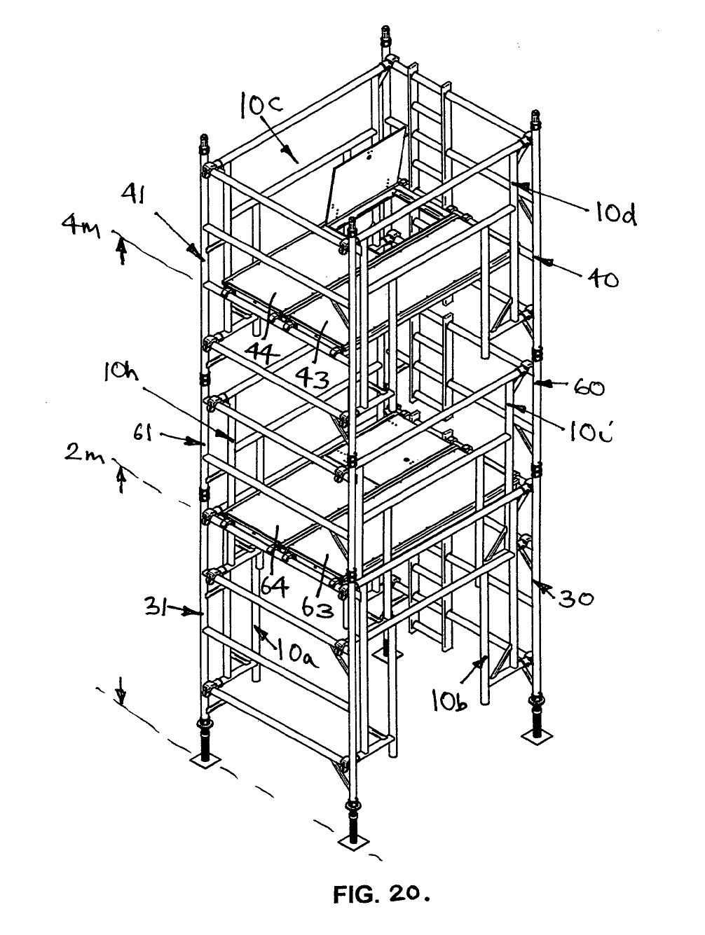

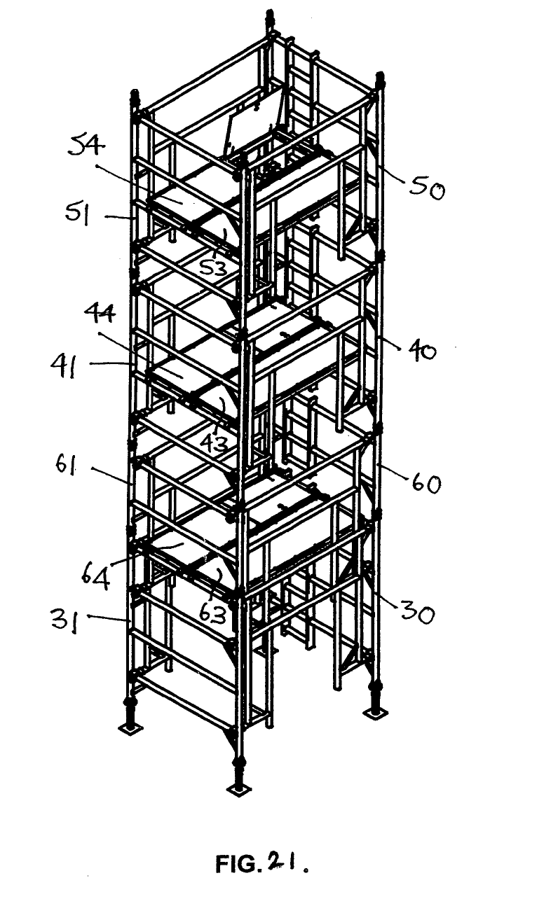

The scaffolding is then completed by erecting the end frames of the next level (see FIG. 18) which are designated with the numbers 40 and 41 previously used in relation to the second full level of scaffolding previously shown in FIG. 10. This next level is completed using side frames 10c and 10d and decking elements 43 and 44 as shown in FIGS. 18 to 20. The lowest remaining level of decking elements 63 and 64 thus lies at two metres above ground level and the next higher level of decking elements 43 and 44 (FIG. 20) lies at four metres above ground level. A yet further level of decking can be added as shown in FIG. 21 which has its decking elements 53 and 54 at six metres above ground level.

FIG. 22 shows the tower of FIG. 21 with two decking elements 53 and 54 at six metres above the ground but single decking elements 44 and 64 at four and two metres above the ground. Also, the side frames 10d and 10i at the four and two metres levels are mounted inboard of the tower adjacent the inner side of the decking elements 44 and 64 respectively. The tower still remains perfectly safe and stable structurally without any additional scaffold elements, thus providing a more economic tower construction which is even quicker to erect.

FIG. 23 shows the tower of FIG. 22 with the horizontal bars of the end frames 30, 31, 40, 41, 60 and 61 at a 250 mm vertical spacing so that the end frames can be used as ladders and no special ladder sections are necessary on the end frames.

As previously stated, the side frames 10 used in the construction of the tower scaffold are full structural units which not only connect the end frames but also provide a mandatory guard rail requirements at the various deck levels above the ground. If desired, the side frames associated with the first or ground level of the decking can be removed and replaced by diagonal bracing pieces 70 and horizontal bracing pieces 71 as shown in FIG. 24. This provides an alternative construction using existing stock components which may already be available to the erector without affecting the safe method of erection described in this invention.

Although the invention is being described above in relation to a tower scaffolding the side frames of the present invention can also be used in other scaffolding structures such as the façade scaffolding structure shown in FIG. 25.

Such a scaffolding structure, which is secured at several points to an adjacent wall 100, uses the same end frames 30, 31, 40, 41, and 50, 51 described above and walk-through frames 80 of the form shown in FIG. 26 which extend in planes at right angles to wall 100. Each walk-through frame 80 has outer vertical tubes 81, a top tube 82 and inner side rails 83 which define an opening H through which operators can walk. Horizontal bracing tubes 84 extend between tubes 81 and 83 and diagonal braces 85 and 86 strengthen the corners of the frame. Spigots 87 at the upper ends of outer tubes 81 are designed to enter the collared lower ends 88 of the outer tubes of the next vertically adjacent walk-thorough frame.

Side frames 10 of the form previously described are secured between the end frames and walk-through frames using the same hook-shaped fastening members 17. The side frames are again secured in their operating position from a lower level of the scaffolding structure so that before the operator climbs onto the decking elements 33, 34 the corresponding side frames are already in position to provide the mandatory guard rail protection. The scaffolding structure on the second and third levels is provided by the end frames, walk-through frames, side frames and decking elements only. On the first or ground level the side frames are replaced by diagonal braces 70.

FIG. 27 shows a scaffolding tower in accordance with the present invention fitted with the necessary stabilizers 90 at each corner. Each stabilizer comprises a diagonal brace 91 and a horizontal brace which are attached to the bottom level end frames by collars 93. These stabilizers have been omitted from the remaining tower drawings for clarity.

The side frame construction of the present invention enables two towers to be bridged by decking elements 140 as shown in FIG. 30. These decking elements are supported between almost identical towers 150 which are basically of the same construction as the tower shown in FIG. 20 with the lower level of decking elements 63 removed in the tower on the right and decking elements 63 and 64 removed from tower on the left.

In order to support the decking elements 140 a strengthened side frame 110 of the form shown in FIGS. 28 and 29 is provided. This side frame is the same as frame 10 with the addition of a vertical strengthening tube 111 between the upper horizontal tube 11 and the second horizontal tube 13 and a second upper horizontal tube 112 which is parallel to and substantially on the same vertical level as upper tube 13. Tube 112 is supported from tubes 111 and 12 via welded buttresses 113. Tube 112 is used to support the decking elements 140 via the decking element hooks 37 described above.

Each of the towers 150 is provided with a side frame 110 at the side of its top level which faces the other tower 150.

As shown in FIG. 31, the connected tower structure of FIG. 30 is constructed by initially connecting the two towers 150 via lower horizontal elements 151 to position the two towers in the correct relationship relative to each other. The upper ends of the towers are also connected by two pairs of horizontal elements 152 and on the inside of each strengthened side frame 110 a pair of side elements 153 are also provided.

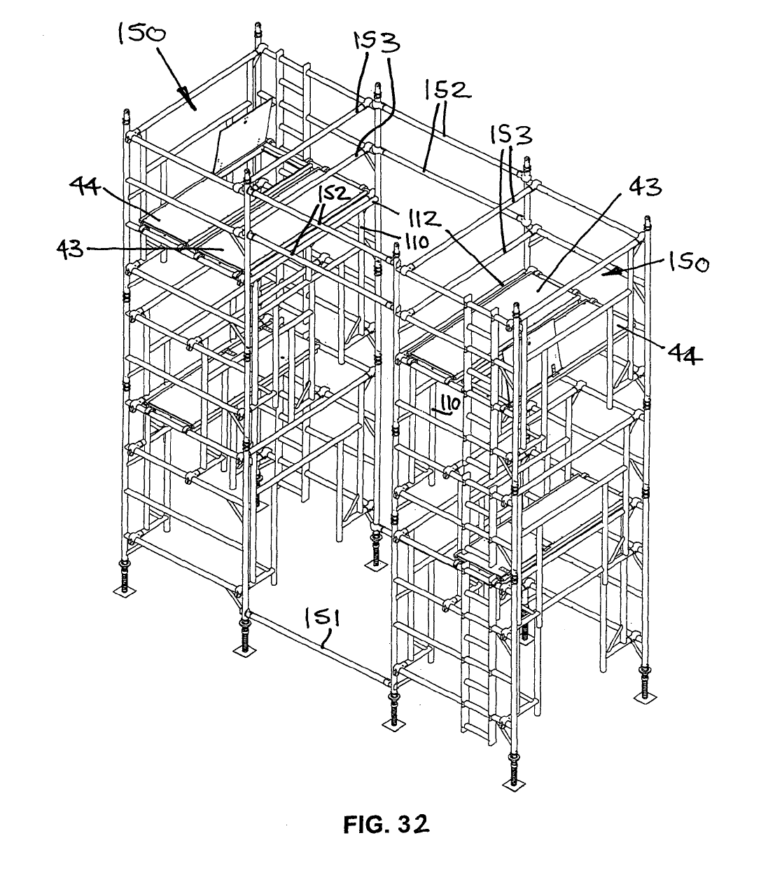

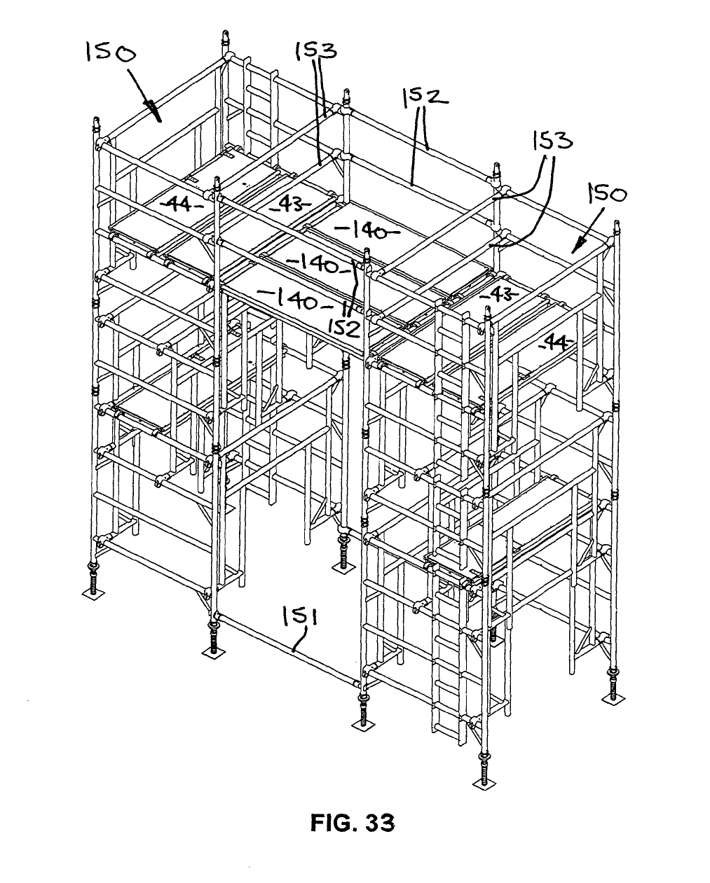

The strengthened side frames 110 are then lowered by a operator standing on the lower decking elements 64 to the positions shown in FIG. 32 in which the second upper horizontal bars 112 lie at the same level as the end frame bars on which the decking elements 43, 44 are supported. As will be appreciated the operators can then secure the decking elements 140 between the two upper horizontal bars 112 whilst standing on decking elements 43, 44 and remain protected against falling by side elements 153. This results in the structure shown in FIG. 33. Finally the side elements 153 are removed to give the structure shown in FIG. 30.

FIG. 34 shows the façade structure of FIG. 25 with only the right hand bay of scaffolding having its decking elements in position at the lower levels since it is unnecessary to retain the decking elements in the other two bays in order to access the top level of the scaffolding structure. Such a structure is termed a “top lifter” structure in the art.

With some façade scaffold structures it is not possible to anchor the structure to the façade and in such circumstances, as shown in FIG. 35, the main façade structure 200 can be stabilised by erecting a small structure 300 next to it which is linked to the main structure 200 by horizontal elements 201 and diagonal elements 202. In this construction only the top level of main façade structure 200 and the small structure 300 is fully decked and only one access bay of the main scaffold 300 is partially decked at the lower intermediate level.

FIG. 36 shows a falsework or shoring structure 350 using side frames in accordance with the present invention used to support a formwork set of beams 400 for supporting casting panels (not shown) for the casting of a concrete floor or similar structure. The beams 400 are carried by ‘U’ shaped supports 401 which are supported on sleeves 402 which fit over the spigots on the upper ends of the verticals of the end frames. This construction not only provides the full support for the concrete being poured into the casting panels supported by the beams 400 but also provides a safe method of the operators erecting this support structure which can have several additional levels above that shown in FIG. 36 when the concrete casting is being undertaken at a greater height.

FIG. 37 shows a façade scaffolding tower structure in which only the top level is fully decked with elements 53, 54 and the side frame which will be adjacent the façade has been omitted. On the lower levels the side frames 10a, 10c which would be normally adjacent the façade have been moved to the centre of the tower to provide unobstructed access to the façade whilst retaining the structural integrity of the tower.

FIG. 38 shows the use of end frames on the bottom level which are of the form shown at 80 in FIG. 26 and which have walk-through gaps P to provide full and easy access below the tower in the two perpendicular directions of access.

FIGS. 46 to 50 show alternative forms of upper fastening members which can be used on a side frame in accordance with the present invention.

In FIG. 46, the upper fastening members 17′ each comprise a U-shaped receiving formation. The limbs of the U-shaped formations extend on either side of the vertical end frame members 30′ as shown in dotted detail in FIG. 46. The plane of each U-shaped formation extends at an angle V of approximately 45 degrees to the vertical so that the U-shaped formations can be easily engaged with the vertical members 30′ when the side frames are inclined to the vertical but move close to the vertical members when the side frame is moved into the vertical position as shown in FIG. 46. The lower fastening members 17 are again hook-shaped. In an alternative arrangement (not shown) the U-shaped members engage horizontal members of the end frames.

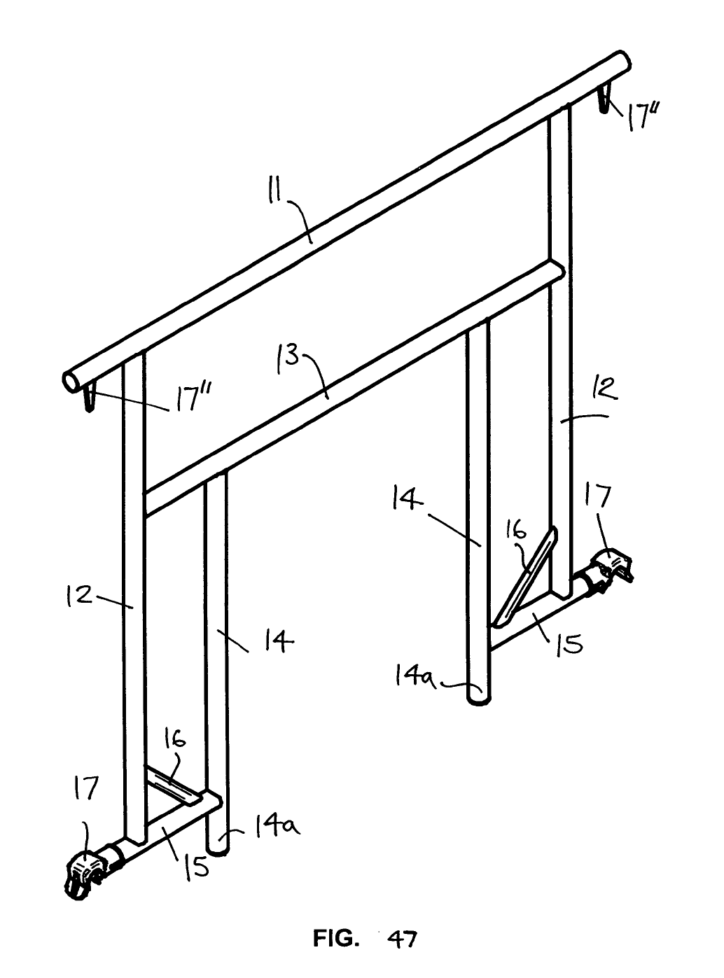

In FIG. 47, the upper fastening members each comprise a projecting pin or wedge 17″ which engages a pocket (not shown) carried by a vertical or horizontal member of the adjacent end frame.

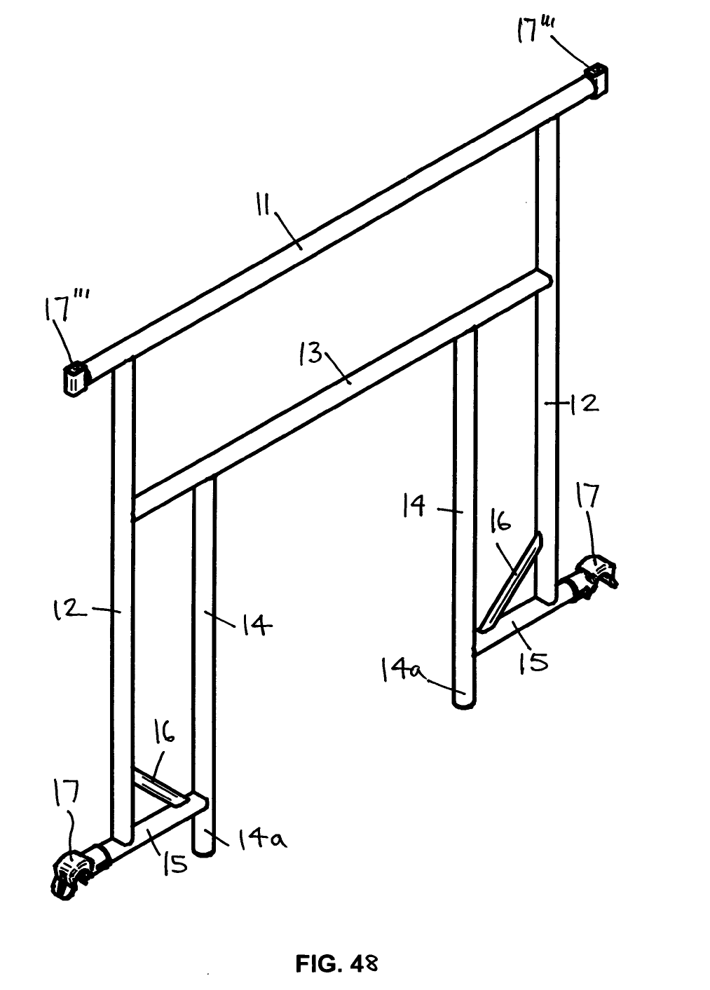

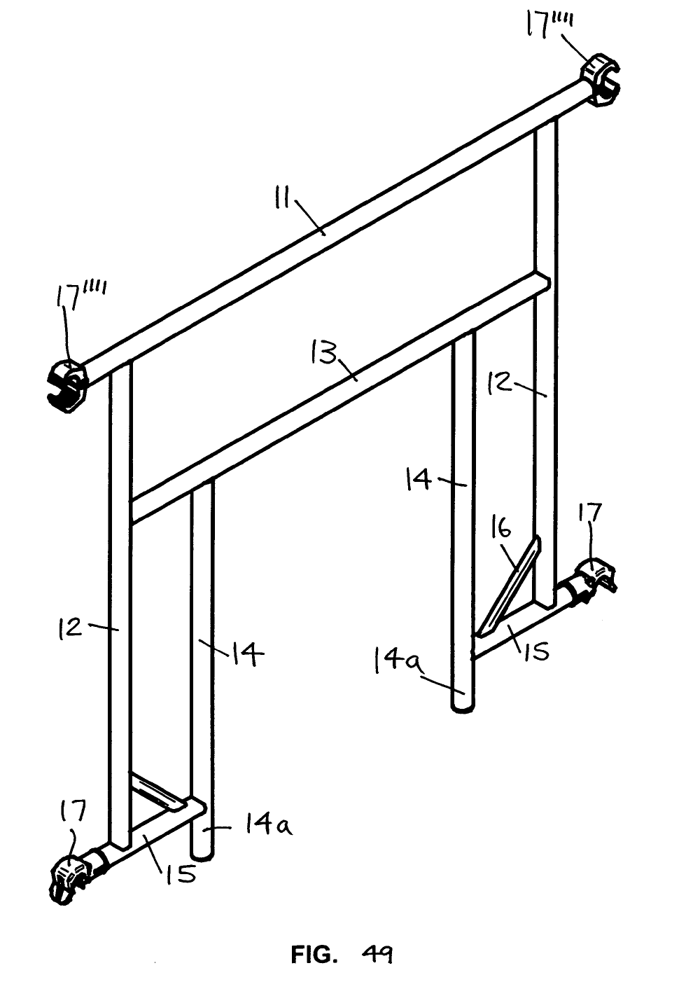

In FIG. 48, the upper fastening members each comprise a pocket 17′″ which receives a projecting pin or wedge (not shown) carried by a vertical or horizontal member of the adjacent end frame.

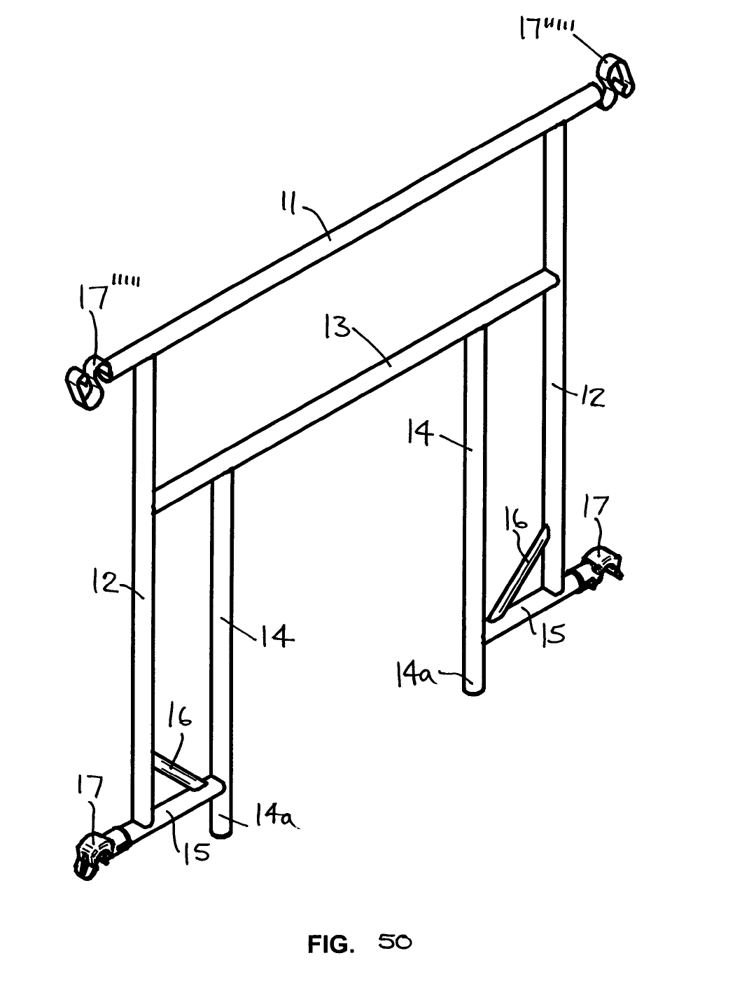

In FIG. 49, the upper fastening members each comprise a clamp 17″″ with pivoting jaws which are spring-loaded towards each other to grip a horizontal or vertical member of the adjacent end frame.

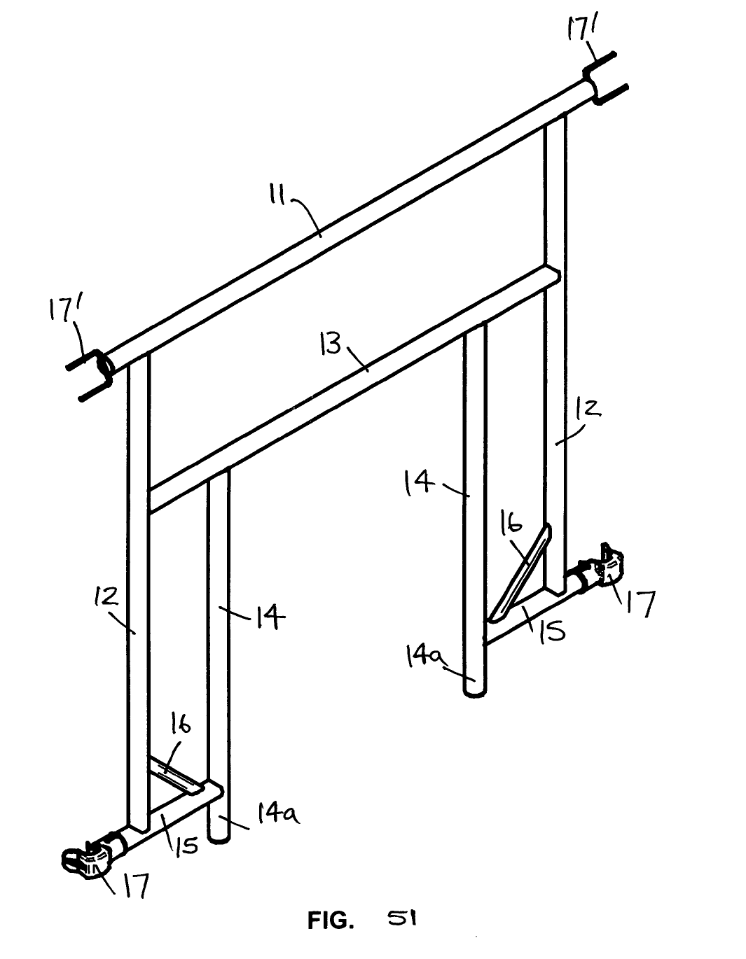

In FIG. 50, the upper fastening members each comprise a strap 17′″″ which is wrapped around a horizontal or vertical member of the adjacent end frame and secured by a Velcro® or other suitable fastening means.

In FIG. 51, U-shaped upper fastening members 17′ are again used but the lower fastening hooks 17 face horizontally so that they can be engaged with adjacent vertical members of the scaffolding by a twisting movement of the side frame about a generally horizontal axis. This horizontally facing orientation of the fastening hooks can be used for both upper and lower hooks on any of the side frame configurations described above. These horizontally facing hooks can be engaged by twisting the side frame about either a horizontal or vertical axis depending on the particular side frame fastening members used on the rest of the side frame.

What is claimed is:

1. A scaffolding side frame comprising at least one generally horizontally extending tube, a pair of vertically extending side tubes depending from the horizontal tube, and four fastening members, one adjacent each corner of the frame, for securing the side frame to a respective adjacent structural element of an associated scaffold structure so that the upper part of the side frame provides a safety rail for an operator standing on a support platform of a given level of a scaffolding structure and the lower part of the side frame extends below the support platform of said given level of the scaffold structure, the two lower fastening members being hook-shaped and the hooks having a fastening latch positioned adjacent the mouth of the hook which when in an active projecting position retains any adjacent structural element within the hook, the latch being displaceable to a retracted position in which the hook can be snapped over the adjacent structural element of the structure, the side frame being mountable in its operating position by an operator holding the lower part of the frame whilst standing on a support platform of a level of the structure below said given level and engaging the fastening members with their respective adjacent structural elements so that the side frame immediately becomes and remains a full load transmitting structural part of the associated scaffold structure, and the configuration of the fastening latches of the lower fastening members preventing the operator disengaging the lower fastening members when stood on the support platform of said given level of the scaffold structure.

2. A side frame according to claim 1 in which the fastening latch of each lower fastening member is spring-loaded towards its active position and can be displaced to its retracted position against the action of the spring loading to allow the adjacent structural element to enter the hook-shaped member as the frame is moved towards the structural element.

3. A side frame according to claim 2 in which the level of spring loading and shape of the fastening latches of the lower fastening members prevent an operator disengaging these fastening members except when the operator is standing in a safe position below the side frame on the lower level of the associated scaffold structure.

4. A side frame according to claim 2 in which the fastening members adjacent the two upper corners are also hook-shaped and are provided with retractable spring-loaded fastening latches, the level of spring loading and shape of the fastening latches of the fastening members adjacent the two upper corners allowing an operator to disengage these fastening members when the operator is standing in a safe position below the side frame on the lower level of the associated scaffold structure.

5. A side frame according to claim 4 in which the fastening latches adjacent each upper corner of the side frame can be set to be retained in their retracted positions in which the adjacent structural element can be disengaged.

6. A side frame according to claim 1 in which the fastening members adjacent the two upper corners each comprise a U-shaped receiving formation, the limbs of each U-shaped formation extending on either side of a vertical or horizontal element of the associated scaffold structure.

7. A side frame according to claim 1 in which the fastening members adjacent the two upper corners each comprise a projecting pin or wedge which engages a pocket carried by a vertical or horizontal element of the associated scaffold structure.

8. A side frame according to claim 1 in which the fastening members adjacent the two upper corners each comprise a pocket which receives a projecting pin or wedge carried by a vertical or horizontal element of the associated scaffold structure.

9. A side frame according to claim 1 in which the fastening members adjacent the two upper corners each comprise a spring-loaded clamp with jaws which engage a vertical of horizontal element of the associated scaffold structure.

10. A side frame according to claim 1 in which the fastening members adjacent the two upper corners each comprise a strap which is wrapped around a vertical or horizontal element of the associated scaffold structure.

11. A side frame according to claim 2 in which, as a safety feature, the latches adjacent each lower corner of the side frames require active pressure on behalf of the operator to hold them in a retracted position for disengagement from the adjacent structural element thus requiring the operator to be on the lower level of the scaffolding.

12. A side frame according to claim 2 in which at least one hook includes a rubber pad which is compressed when the adjacent structural element is retained in the hook to prevent sideways slipping of the hook relative to the structural element.

13. A side frame according to claim 2 in which the spring loading of the latches of the lower hooks supports the weight of the side frame on the latches without the latches being displaced to their retracted position.

14. A side frame according to claim 2 in which adjacent each upper fastening member the side frame includes a cam member which tends to guide the fastening member into engagement with the adjacent structural element as the side frame is moved towards the element.

15. A side frame according to claim 1 in which the outer end of each hook-shaped fastening member also includes a beak portion with a cam surface to guide the hook over the adjacent structural element as the side frame is moved towards the element.

16. (canceled)

17. (canceled)

18. A side frame according to claim 1 comprising two generally horizontal vertically spaced guard rails which form an upper part of the side frame when the frame is in its operating position and two pairs of downwardly extending side tubes at each end of the horizontal guard rails which form a lower part of the side frame, to give the side frame an inverted U-shaped configuration with an operator access opening in the central lower part of the side frame, the lower ends of each pair of side tubes being joined by respective horizontal lower tubes.

19. A side frame according to claim 18 in which the inner of each pair of downwardly extending side tubes extends below the respective horizontal lower tube to provide a handhold for the operator to raise the side frame into its operating position.

20. (canceled)

21. (canceled)

22. (canceled)

23. A multi-level tower scaffolding comprising a series of end frames, each end frame comprising vertical corner tubes with horizontal end tube members extending between the corner tubes, the end frames being positioned one above each other with decking elements extending between the end frames at a plurality of levels, one or more of the levels of end frames being joined by two side frames in accordance with claim 1.

24. A tower scaffolding according to claim 23 in which the fastening members adjacent the corners of the side frames engage the horizontal end tube members of the end frames.

25. tower scaffolding according to claim 23 in which at least one of the lower levels of decking elements is of reduced width with one of the side frames of said at least one level mounted inboard of the tower along an inner edge of the reduced width decking element.

26. (canceled)

27. (canceled)

28. (canceled)

29. (canceled)

30. (canceled)

31. (canceled)

32. A multi-level scaffolding structure comprising vertical scaffold components connected by generally horizontal scaffold components from which decking elements are supported at different levels in the structure, at least one pair of vertical components of the structure having a side frame in accordance with claim 1 secured therebetween, the side frame being connected with horizontal scaffold components connected to the pair of vertical components.

33. (canceled)

34. A method of erecting at least part of a multi-level scaffolding structure comprising vertical scaffold components connected by generally horizontal scaffold components from which decking elements are supported at different levels in the structure, the vertical components also being connected by other scaffolding components which provide a guard rail function and complete the structural integrity of the scaffolding structure, said method including the step of erecting at least part of the other scaffolding components using a side frame which extends between an adjacent pair of vertical components of said structure, the side frame being in accordance with claim 1 and providing the mandatory guard rail between the adjacent pair of vertical components and being a structural component designed to complete the structural integrity of the structure during the erection and to remain in position throughout the subsequent use of the structure, the method including raising the side frame into position and fully engaging the fastening members of the side frame to grip scaffold components of a higher level of the structure using an operator standing on a decking element of a lower level of the scaffolding structure, and positioning the decking elements of the higher level between horizontal scaffold components of the higher level thus fully completing said higher level before the operator climbs to said higher level.

35. (canceled)

36. (canceled)

37. A façade scaffolding tower comprising a scaffolding tower according to claim 23 in which on the top level of the tower the side frame to be adjacent the façade is omitted and on lower levels the side frames to be adjacent the façade are moved to the centre of the tower.

38. (canceled)

39. (canceled)

40. (canceled)

41. (canceled)
